(19) United States
(12) Patent Application Publication
(10) Pub. No.: US 2021/0177053 A1
(43) Pub. Date: Jun. 17, 2021

(54) RESEALABLE CARTRIDGE ASSEMBLY FOR AN AEROSOL-GENERATING SYSTEM

(71) Applicant: PHILIP MORRIS PRODUCTS S.A., Neuchatel (CH)

(72) Inventors: Jonathan Hogwood, Trumpington (GB); Stuart Michael Ruan Jones, Melbourn (GB); Neil Anthony Litten, Sonning (GB); Darren Seymour, Huntingdon (GB); John Antony Stephenson, Cherry Hinton (GB); William Frank Tyldesley, Diss (GB)

(21) Appl. No.: 17/057,877

(22) PCT Filed: Jun. 21, 2019
(86) PCT No.: PCT/EP2019/066541

§ 371 Date: Nov. 23, 2020

(30) Foreign Application Priority Data
Jun. 21, 2018 (EP) 18179131.0

(51) Int. Cl. A24F 40/42; A24F 40/10; A24F 40/465

(52) U.S. Cl. CPC A24F 40/42; A24F 40/465; A24F 40/10

(57) ABSTRACT

A cartridge assembly (2, 200) for use in an aerosol-generating system comprises: a cartridge (4) having an upstream end and a downstream end, the cartridge (4) comprising: at least one compartment (12, 14) having an air inlet at the upstream end of the cartridge (4) and an air outlet downstream of the air inlet; a removable first seal (20) secured to the upstream end of the cartridge (4), wherein the removable first seal (20) obstructs the air inlet of the at least one compartment (12, 14) and is configured to be removed by a user prior to use of the cartridge assembly (2); and a cartridge actuation portion (18) on an inner surface of a downstream end portion of the cartridge (4). The cartridge assembly (2) also comprises: a mouthpiece comprising: a mouthpiece body portion (22) having an upstream end and a downstream end, the mouthpiece body portion (22) having an air inlet at the upstream end of the mouthpiece body portion (22) and an air outlet at the downstream end of the mouthpiece body portion (22); a second seal (26) at the upstream end of the mouthpiece body portion (22); and a mouthpiece actuation portion (28) on an outer surface of the mouthpiece body portion (22). The mouthpiece actuation portion (28) is engaged with the cartridge actuation portion (18) and the mouthpiece actuation portion (28) and the cartridge actuation portion (18) are configured so that the mouthpiece body portion (22) is moveable with respect to the cartridge (4) from a first position, in which first position the second seal (26) abuts and obstructs the air outlet of the at least one compartment (12, 14), to a second position, in which second position the second seal (26) is spaced apart from the air outlet of the at least one compartment (12, 14) and the air outlet of the at least one compartment (12, 14) is in fluid communication with the air inlet of the mouthpiece body portion (22).

The present invention relates to a cartridge assembly for use in an aerosol-generating system and an aerosol-generating system comprising the cartridge assembly. The present invention finds particular application as a cartridge assembly comprising a nicotine source and an acid source for the generation of an aerosol comprising nicotine salt particles.

Devices for delivering nicotine to a user comprising a nicotine source and a volatile delivery enhancing compound source are known. For example, WO 2008/121610 A1 discloses devices in which nicotine and a volatile acid, such as pyruvic acid, are reacted with one another in the gas phase to form an aerosol of nicotine salt particles that is inhaled by the user. WO 2008/121610 A1 discloses that the nicotine source and the volatile delivery enhancing compound source may be manufactured and stored as independent components that are sealed by frangible barrier end caps prior to first use of the device. However, once the frangible barrier end caps have been penetrated to unseal the nicotine source and the volatile delivery enhancing compound source prior to first use of the device, volatile delivery enhancing compound and nicotine may be lost from the nicotine source and the volatile delivery enhancing compound source between subsequent uses of the device.

According to the invention there is provided a cartridge assembly for use in an aerosol-generating system, the cartridge assembly comprising a cartridge and a mouthpiece. The cartridge has an upstream end and a downstream end and comprises: at least one compartment having an air inlet at the upstream end of the cartridge and an air outlet downstream of the air inlet; a removable first seal secured to the upstream end of the cartridge, wherein the removable first seal obstructs the air inlet of the at least one compartment and is configured to be removed by a user prior to use of the cartridge assembly; and a cartridge actuation portion on an inner surface of a downstream end portion of the cartridge. The mouthpiece comprises: a mouthpiece body portion having an upstream end and a downstream end, the mouthpiece body portion having an air inlet at the upstream end of the mouthpiece body portion and an air outlet at the downstream end of the mouthpiece body portion; a second seal at the upstream end of the mouthpiece body portion; and a mouthpiece actuation portion on an outer surface of the mouthpiece body portion. The mouthpiece actuation portion is engageable with the cartridge actuation portion and the mouthpiece actuation portion and the cartridge actuation portion are configured so that the mouthpiece body portion is moveable with respect to the cartridge from a first position, in which first position the second seal abuts and obstructs the air outlet of the at least one compartment, to a second position, in which second position the second seal is spaced apart from the air outlet of the at least one compartment and the air outlet of the at least one compartment is in fluid communication with the air inlet of the mouthpiece body portion.

As used herein with reference to the invention, the term “air inlet” is used to describe one or more apertures through which air may be drawn into a component or portion of a component of the cartridge assembly.

As used herein with reference to the invention, the term “air outlet” is used to describe one or more apertures through which air may be drawn out of a component or portion of a component of the cartridge assembly.

As used herein with reference to the invention, the term “obstructed” is used to describe an air inlet or an air outlet that is blocked such that airflow through the air inlet or the air outlet is substantially prevented.

As used herein with reference to the invention, the term “inner surface” is used to describe an inwardly facing surface.

As used herein with reference to the invention, the term “outer surface” is used to describe an outwardly facing surface.

The removable first seal and the second seal of the cartridge assembly according to the invention advantageously minimise or substantially prevent loss of contents from the at least one compartment of the cartridge prior to first use of the cartridge assembly in an aerosol-generating system.

Obstruction of the air inlet of the at least one compartment of the cartridge by the removable first seal and obstruction of the air outlet of the at least one compartment of the cartridge by the second seal when the mouthpiece body portion of the mouthpiece is in the first position minimises or substantially prevents loss of contents from the at least one compartment of the cartridge through the air inlet and the air outlet of the at least one compartment of the cartridge prior to use of the cartridge assembly in an aerosol-generating system.

The removable first seal is configured to be removed from the cartridge assembly by a user prior to use of the cartridge assembly. The removable first seal is configured to be disposed of by a user after removal from the cartridge assembly.

Removal of the removable first seal and movement of the mouthpiece body portion of the mouthpiece with respect to the cartridge from the first position to the second position creates an airflow pathway through the at least one compartment of the cartridge.

When the removable first seal is removed the air inlet of the at least one compartment of the cartridge is unobstructed and when the mouthpiece body portion of the mouthpiece is moved with respect to the cartridge from the first position to the second position the air outlet of the at least one compartment of the cartridge is unobstructed. This allows an air stream to be drawn into the at least one compartment of the cartridge through the air inlet of the at least one compartment and out of the at least one compartment of the cartridge through the air outlet of the at least one compartment.

As used herein with reference to the invention, the terms “proximal”, “distal”, “upstream” and “downstream” are used to describe the relative positions of components, or portions of components, of the cartridge assembly.

The cartridge assembly according to the invention comprises a proximal end through which, in use, aerosol exits the cartridge assembly for delivery to a user. The proximal end may also be referred to as the mouth end. In use, a user draws on the proximal end of the cartridge assembly in order to inhale an aerosol generated by an aerosol-generating system comprising the cartridge assembly. The cartridge assembly comprises a distal end opposed to the proximal end.

Components, or portions of components, of the cartridge assembly may be described as being upstream or downstream of one another based on their relative positions between the proximal end and the distal end of the cartridge assembly.

The mouthpiece is located at the proximal end of the cartridge assembly. The cartridge is located upstream of the mouthpiece.

The air inlet of the at least one compartment of the cartridge of the cartridge assembly is located at the upstream end of the cartridge. The air outlet of the at least one compartment of the cartridge of the cartridge assembly is located downstream of the air inlet of the at least one compartment of the cartridge of the cartridge assembly.

As used herein with reference to the invention, the term “downstream” is also used to describe direction of movement away from the distal end and towards the proximal end of the cartridge assembly and the term “upstream” is used to describe direction of movement away from the proximal end and towards the distal end of the cartridge assembly.

As used herein with reference to the invention, the term “longitudinal” is used to describe the direction between the proximal end and the opposed distal end of the cartridge assembly and the term “transverse” is used to describe the direction perpendicular to the longitudinal direction.

As used herein with reference to the invention, the term “length” is used to describe the maximum longitudinal dimension of components, or portions of components, of the cartridge assembly parallel to the longitudinal axis between the proximal end and the opposed distal end of the cartridge assembly.

As used herein with reference to the invention, the terms “height” and “width” are used to describe the maximum transverse dimensions of components, or portions of components, of the cartridge assembly perpendicular to the longitudinal axis of the cartridge assembly. Where the height and width of components, or portions of components, of the cartridge assembly are not the same, the term “width” is used to refer to the larger of the two transverse dimensions perpendicular to the longitudinal axis of the cartridge assembly.

As used herein with reference to the invention, the term “elongate” is used to describe a component or portion of a component of the cartridge assembly having a length greater than the width and height thereof.

The cartridge assembly may be supplied to a user with the mouthpiece actuation portion engaged with the cartridge actuation portion.

The cartridge and the mouthpiece of the cartridge assembly may be supplied as separate components to a user. In such embodiments, the mouthpiece actuation portion may be engaged with the cartridge actuation portion by the user prior to use of the cartridge assembly.

Advantageously, the mouthpiece actuation portion and the cartridge actuation portion are configured for two-way movement of the mouthpiece body portion with respect to the cartridge. In such embodiments, the mouthpiece body portion of the mouthpiece is moveable with respect to the cartridge from the first position to the second position and the mouthpiece body portion of the mouthpiece is moveable with respect to the cartridge from the second position to the first position.

Movement of the mouthpiece body portion of the mouthpiece with respect to the cartridge from the second position back to the first position re-obstructs the air outlet of the at least one compartment of the cartridge. This reduces loss of remaining contents from the at least one compartment of the cartridge through the air outlet of the at least one compartment when an aerosol-generating system comprising the cartridge assembly is not in use.

Reversible “opening” and closing” of the air outlet of the at least one compartment of the cartridge through movement of the mouthpiece body portion of the mouthpiece with respect to the cartridge between the first position and the second position may thereby advantageously increase the consumable life of the cartridge assembly according to the invention compared to devices as disclosed in WO 2008/121610 A1 in which the nicotine source and the volatile delivery enhancing compound source are sealed by frangible barrier end caps.

By moving the mouthpiece body portion of the mouthpiece with respect to the cartridge from the second position to the first position between each use, sufficient contents of the at least one compartment of the cartridge of the cartridge assembly according to the invention may advantageously be retained to generate a desired aerosol for delivery to a user upon each use of an aerosol-generating system comprising the cartridge assembly.

The cartridge actuation portion may comprise a guide slot provided on an inner surface of a downstream end portion of the cartridge of the cartridge assembly and the mouthpiece actuation portion may comprise a projection provided on an outer surface of the mouthpiece body portion of the mouthpiece of the cartridge assembly, wherein the projection is engaged with the guide slot.

The cartridge actuation portion may comprise a projection provided on an inner surface of a downstream end portion of the cartridge of the cartridge assembly and the mouthpiece actuation portion may comprise a guide slot provided on an outer surface of the mouthpiece body portion of the mouthpiece of the cartridge assembly, wherein the projection is engaged with the guide slot.

Using a combination of a guide slot and a projection may provide a simple means for effecting movement of the mouthpiece body portion with respect to the cartridge.

A combination of a single guide slot and a plurality of projections may be used to effect movement of the mouthpiece body portion with respect to the cartridge.

The cartridge actuation portion may comprise a single guide slot provided on an inner surface of a downstream end portion of the cartridge of the cartridge assembly and the mouthpiece actuation portion may comprise a plurality of projections provided on an outer surface of the mouthpiece body portion of the mouthpiece of the cartridge assembly, wherein each of the plurality of projections is engaged with the guide slot.

The cartridge actuation portion may comprise a plurality of projections provided on an inner surface of a downstream end portion of the cartridge of the cartridge assembly and the mouthpiece actuation portion may comprise a single guide slot provided on an outer surface of the mouthpiece body portion of the mouthpiece of the cartridge assembly, wherein each of the plurality of projections is engaged with the guide slot.

A combination of a plurality of guide slots and a plurality of projections may be used to effect movement of the mouthpiece body portion with respect to the cartridge.

The cartridge actuation portion may comprise a plurality of guide slots provided on an inner surface of a downstream end portion of the cartridge of the cartridge assembly and the mouthpiece actuation portion may comprise a plurality of projections provided on an outer surface of the mouthpiece body portion of the mouthpiece of the cartridge assembly, wherein each of the plurality of projections is engaged with one of the plurality of guide slots.

The cartridge actuation portion may comprise a plurality of projections provided on an inner surface of a downstream end portion of the cartridge of the cartridge assembly and the mouthpiece actuation portion may comprise a plurality of guide slots provided on an outer surface of the mouthpiece body portion of the mouthpiece of the cartridge assembly, wherein each of the plurality of projections is engaged with one of the plurality of guide slots.

Using a combination of one or more guide slots and a plurality of projections may assist in balancing and maintaining alignment of the mouthpiece body portion relative to the cartridge during movement of the mouthpiece body portion with respect to the cartridge.

In embodiments in which the cartridge actuation portion comprises a plurality of guide slots provided on an inner surface of a downstream end portion of the cartridge of the cartridge assembly, the plurality of guide slots may be spaced-apart around the inner surface of the downstream end portion of the cartridge of the cartridge assembly.

In embodiments in which the mouthpiece actuation portion comprises a plurality of projections provided on an outer surface of the mouthpiece body portion of the mouthpiece of the cartridge assembly, the plurality of projections may be spaced-apart around the outer surface of the mouthpiece body portion of the mouthpiece of the cartridge assembly.

In embodiments in which the cartridge actuation portion comprises a plurality of projections provided on an inner surface of a downstream end portion of the cartridge of the cartridge assembly, the plurality of projections may be spaced-apart around the inner surface of the downstream end portion of the cartridge of the cartridge assembly.

In embodiments in which the mouthpiece actuation portion comprises a plurality of guide slots provided on an outer surface of the mouthpiece body portion of the mouthpiece of the cartridge assembly, the plurality of guide slots may be spaced-apart around the outer surface of the mouthpiece body portion of the mouthpiece of the cartridge assembly.

The mouthpiece actuation portion and the cartridge actuation portion may be configured so that the mouthpiece body portion is translationally moveable with respect to the cartridge.

In embodiments in which the mouthpiece body portion is translationally moveable with respect to the cartridge, the cartridge actuation portion may comprise a longitudinal guide slot provided on an inner surface of a downstream end portion of the cartridge of the cartridge assembly and the mouthpiece actuation portion may comprise a projection provided on an outer surface of the mouthpiece body portion of the mouthpiece of the cartridge assembly, wherein the projection is engaged with the longitudinal guide slot.

In embodiments in which the mouthpiece body portion is translationally moveable with respect to the cartridge, the cartridge actuation portion may comprise a projection provided on an inner surface of a downstream end portion of the cartridge of the cartridge assembly and the mouthpiece actuation portion may comprise a longitudinal guide slot provided on an outer surface of the mouthpiece body portion of the mouthpiece of the cartridge assembly, wherein the projection is engaged with the longitudinal guide slot.

Using a combination of a longitudinal guide slot and a projection may provide a simple means for effecting translational movement of the mouthpiece body portion with respect to the cartridge.

The projection may engage a first end of the longitudinal guide slot when the mouthpiece body portion is in the second position relative to the cartridge. The engagement of the first projection and the first end of the longitudinal guide slot may prevent further translational movement of the mouthpiece body portion with respect to the cartridge in a direction away from the first position.

In embodiments in which the mouthpiece body portion is configured for two-way helicoidal movement with respect to the cartridge, the projection may engage a second end of the longitudinal guide slot when the mouthpiece body portion is in the first position relative to the cartridge. The engagement of the first projection and the second end of the longitudinal guide slot may prevent further translational movement of the mouthpiece body portion with respect to the cartridge in a direction away from the second position.

Limiting the range of translational movement of the mouthpiece body portion with respect to the cartridge may prevent the application of excessive force to the mouthpiece body portion by a user, which may damage the cartridge assembly.

The mouthpiece actuation portion and the cartridge actuation portion may be configured so that the mouthpiece body portion is translationally and rotationally moveable with respect to the cartridge.

The mouthpiece actuation portion and the cartridge actuation portion may be configured so that the mouthpiece body portion is helicoidally moveable with respect to the cartridge.

In embodiments in which the mouthpiece body portion is helicoidally moveable with respect to the cartridge, the cartridge actuation portion may comprise a helical guide slot provided on an inner surface of a downstream end portion of the cartridge of the cartridge assembly and the mouthpiece actuation portion may comprise a projection provided on an outer surface of the mouthpiece body portion of the mouthpiece of the cartridge assembly, wherein the projection is engaged with the helical guide slot.

In embodiments in which the mouthpiece body portion is helicoidally moveable with respect to the cartridge, the cartridge actuation portion may comprise a projection provided on an inner surface of a downstream end portion of the cartridge of the cartridge assembly and the mouthpiece actuation portion may comprise a helical guide slot provided on an outer surface of the mouthpiece body portion of the mouthpiece of the cartridge assembly, wherein the projection is engaged with the helical guide slot.

Using a combination of a helical guide slot and a projection may provide a simple means for effecting helicoidal movement of the mouthpiece body portion with respect to the cartridge. A combination of a helical guide slot and a projection may transform rotational force applied to the mouthpiece body portion into helicoidal movement of the mouthpiece body portion with respect to the cartridge.

The projection may engage a first end of the helical guide slot when the mouthpiece body portion is in the second position relative to the cartridge. The engagement of the first projection and the first end of the helical guide slot may prevent further helicoidal movement of the mouthpiece body portion with respect to the cartridge in a direction away from the first position.

In embodiments in which the mouthpiece body portion is configured for two-way helicoidal movement with respect to the cartridge, the projection may engage a second end of the helical guide slot when the mouthpiece body portion is in the first position relative to the cartridge. The engagement of the first projection and the second end of the helical guide slot may prevent further helicoidal movement of the mouthpiece body portion with respect to the cartridge in a direction away from the second position.

Limiting the range of helicoidal movement of the mouthpiece body portion with respect to the cartridge may prevent excessive turning of the mouthpiece body portion by a user, which may damage the cartridge assembly.

The cartridge actuation portion may comprise a first helical thread provided on an inner surface of a downstream end portion of the cartridge of the cartridge assembly and the mouthpiece actuation portion may comprise a second helical thread provided on an outer surface of the mouthpiece body portion of the mouthpiece of the cartridge assembly, wherein the second helical thread is engaged with the first helical thread.

Using a combination of a first helical thread and a second helical thread may provide a simple means for effecting helicoidal movement of the mouthpiece body portion with respect to the cartridge. A combination of a first helical thread and a second helical thread may transform rotational force applied to the mouthpiece body portion into helicoidal movement of the mouthpiece body portion with respect to the cartridge.

The cartridge of the cartridge assembly may comprise a first mechanical stop and the mouthpiece body portion of the mouthpiece of the cartridge assembly may comprise a second mechanical stop.

The first mechanical stop may engage the second mechanical stop when the mouthpiece body portion is in the second position relative to the cartridge. The engagement of the first mechanical stop and the second mechanical stop may prevent further movement of the mouthpiece body portion with respect to the cartridge in a direction away from the first position. Where the mouthpiece actuation portion and the cartridge actuation portion are configured so that the mouthpiece body portion is translationally and rotationally moveable with respect to the cartridge, limiting the range of movement of the mouthpiece body portion with respect to the cartridge may prevent excessive turning of the mouthpiece body portion by a user, which may damage the cartridge assembly.

The engagement of the first mechanical stop and the second mechanical stop may produce an audible click to indicate to a user that the mouthpiece body portion has reached the second position.

The first mechanical stop may engage the second mechanical stop when the mouthpiece body portion is in the first position relative to the cartridge. The engagement of the first mechanical stop and the second mechanical stop may prevent further movement of the mouthpiece body portion with respect to the cartridge in a direction away from the second position. Where the mouthpiece actuation portion and the cartridge actuation portion are configured so that the mouthpiece body portion is translationally and rotationally moveable with respect to the cartridge, limiting the range of movement of the mouthpiece body portion with respect to the cartridge may prevent excessive turning of the mouthpiece body portion by a user, which may damage the cartridge assembly.

In embodiments in which the mouthpiece body portion is configured for two-way helicoidal movement with respect to the cartridge, the engagement of the first mechanical stop and the second mechanical stop may produce an audible click to indicate to a user that the mouthpiece body portion has reached the second position.

In embodiments in which the mouthpiece actuation portion and the cartridge actuation portion are configured so that the mouthpiece body portion is translationally and rotationally moveable with respect to the cartridge, the cartridge assembly may be configured to define the second position of the mouthpiece body portion at an angular rotation with respect to the cartridge of between about 70 degrees and about 110 degrees from the first position. For example, the cartridge assembly may be configured to define the second position of the mouthpiece body portion at an angular rotation with respect to the cartridge of between about 80 degrees and about 100 degrees from the first position or at an angular rotation with respect to the cartridge of about 90 degrees from the first position.

The cartridge assembly may be configured to define the second position of the mouthpiece body portion at an angular rotation with respect to the cartridge of between about 160 degrees and about 200 degrees from the first position. For example, the cartridge assembly may be configured to define the second position of the mouthpiece body portion at an angular rotation with respect to the cartridge of between about 170 degrees and about 190 degrees from the first position or at an angular rotation with respect to the cartridge of about 180 degrees from the first position.

The cartridge assembly may be configured to define the second position of the mouthpiece body portion at an angular rotation with respect to the cartridge of between about 340 degrees and about 380 degrees from the first position. For example, the cartridge assembly may be configured to define the second position of the mouthpiece body portion at an angular rotation with respect to the cartridge of between about 350 degrees and about 370 degrees from the first position or at an angular rotation with respect to the cartridge of about 360 degrees from the first position.

Configuring the cartridge assembly to define the second position of the mouthpiece body portion at an angular rotation within the above ranges with respect to the cartridge from the first position may facilitate turning of the mouthpiece body portion by a user from the first position to the second position in a single motion.

The mouthpiece actuation portion may be provided on an outer surface of an upstream end portion of the mouthpiece body portion.

The air inlet of the at least one compartment of the cartridge of the cartridge assembly may comprise one or more apertures. For example, the air inlet of the at least one compartment of the cartridge may comprise one, two, three, four, five, six or seven apertures.

The air outlet of the at least one compartment of the cartridge of the cartridge assembly may comprise one or more apertures. For example, the air outlet of the at least one compartment of the cartridge may comprise one, two, three, four, five, six or seven apertures.

The cartridge of the cartridge assembly may comprise a single compartment having an air inlet at the upstream end of the cartridge and an air outlet downstream of the air inlet.

The cartridge of the cartridge assembly may comprise a plurality of compartments each having an air inlet at the upstream end of the cartridge and an air outlet downstream of the air inlet.

In such embodiments, the removable first seal may obstruct the air inlet of each of the plurality of compartments.

In such embodiments, the mouthpiece actuation portion and the cartridge actuation portion may be configured so that the mouthpiece body portion is moveable with respect to the cartridge from a first position in which the second seal abuts and obstructs the air outlet of each of the plurality of compartments to a second position in which the second seal is spaced apart from the air outlet of each of the plurality of compartments and the air outlet of each of the plurality of compartments is in fluid communication with the air inlet of the mouthpiece body portion.

Advantageously, the at least one compartment may comprise a first compartment having a first air inlet at the upstream end of the cartridge and a first air outlet downstream of the first air inlet and a second compartment having a second air inlet at the upstream end of the cartridge and a second air outlet downstream of the first air inlet. This allows two reactants to be housed separately within the cartridge of the cartridge assembly.

In such embodiments, the removable first seal may obstruct the first air inlet of the first compartment and the second air inlet of the second compartment.

In such embodiments, the mouthpiece actuation portion and the cartridge actuation portion may be configured so that the mouthpiece body portion is moveable with respect to the cartridge from a first position in which the second seal abuts and obstructs the first air outlet of the first compartment and the second air outlet of the second compartment to a second position in which the second seal is spaced apart from the first air outlet of the first compartment and the second air outlet of the second compartment and the first air outlet of the first compartment and the second air outlet of the second compartment are in fluid communication with the air inlet of the mouthpiece body portion.

In such embodiments, when the mouthpiece body portion of the mouthpiece is in the second position relative to the cartridge, a first air stream may be drawn through the first compartment of the cartridge and a second air stream may be drawn through the second compartment of the cartridge.

For example, a first reactant may be housed in the first compartment of the cartridge of the cartridge assembly and a second reactant may be housed in the second compartment of the cartridge of the cartridge assembly. In use, when the mouthpiece body portion of the mouthpiece is in the second position relative to the cartridge, the first reactant may be entrained in a first air stream drawn through the first compartment of the cartridge and the second reactant may be entrained in a second air stream drawn through the second compartment of the cartridge. The first reactant entrained in the first air stream and the second reactant entrained in the second air stream may react with one another in the mouthpiece to form a reaction product, which is delivered to the user through the air outlet of the mouthpiece body portion.

Advantageously, the cartridge of the cartridge assembly may comprise a nicotine source within the first compartment and an acid source within the second compartment.

As used herein with reference to the invention, the term “nicotine”, is used to describe nicotine, nicotine base or a nicotine salt.

The nicotine source may comprise natural nicotine or synthetic nicotine.

The nicotine source may comprise a first carrier material impregnated with nicotine.

The nicotine source may comprise a first carrier material impregnated with between about 1 milligram and about 50 milligrams of nicotine. The nicotine source may comprise a first carrier material impregnated with between about 1 milligram and about 40 milligrams of nicotine. Preferably, the nicotine source comprises a first carrier material impregnated with between about 3 milligrams and about 30 milligrams of nicotine. More preferably, the nicotine source comprises a first carrier material impregnated with between about 6 milligrams and about 20 milligrams of nicotine. Most preferably, the nicotine source comprises a first carrier material impregnated with between about 8 milligrams and about 18 milligrams of nicotine.

In embodiments in which the first carrier material is impregnated with nicotine base or a nicotine salt, the amounts of nicotine recited herein are the amount of nicotine base or amount of ionised nicotine, respectively.

The first carrier material may be impregnated with liquid nicotine or a solution of nicotine in an aqueous or non-aqueous solvent.

The acid source may comprise an organic acid or an inorganic acid.

Preferably, the acid source comprises an organic acid, more preferably a carboxylic acid, most preferably an alpha-keto or 2-oxo acid or lactic acid.

Advantageously, the acid source comprises an acid selected from the group consisting of 3-methyl-2-oxopentanoic acid, pyruvic acid, 2-oxopentanoic acid, 4-methyl-2-oxopentanoic acid, 3-methyl-2-oxobutanoic acid, 2-oxooctanoic acid, lactic acid and combinations thereof. Advantageously, the acid source comprises pyruvic acid or lactic acid. More advantageously, the acid source comprises lactic acid.

The acid source may comprise a second carrier material impregnated with acid.

The first carrier material and the second carrier material may be the same or different.

Advantageously, the first carrier material and the second carrier material have a density of between about 0.1 grams/cubic centimetre and about 0.3 grams/cubic centimetre.

Advantageously, the first carrier material and the second carrier material have a porosity of between about 15 percent and about 55 percent.

The first carrier material and the second carrier material may comprise one or more of glass, cellulose, ceramic, stainless steel, aluminium, polyethylene (PE), polypropylene, polyethylene terephthalate (PET), poly(cyclohexanedimethylene terephthalate) (PCT), polybutylene terephthalate (PBT), polytetrafluoroethylene (PTFE), expanded polytetrafluoroethylene (ePTFE), and BAREX®.

The first carrier material acts as a reservoir for the nicotine.

Advantageously, the first carrier material is chemically inert with respect to nicotine.

The first carrier material may have any suitable shape and size. For example, the first carrier material may be in the form of a sheet or plug.

Advantageously, the shape and size of the first carrier material is similar to the shape and size of the first compartment of the cartridge of the cartridge assembly.

The shape, size, density and porosity of the first carrier material may be chosen to allow the first carrier material to be impregnated with a desired amount of nicotine.

Advantageously, the first compartment of the cartridge may further comprise a flavourant. Suitable flavourants include, but are not limited to, menthol.

Advantageously, the first carrier material may be impregnated with between about 3 milligrams and about 12 milligrams of flavourant.

The second carrier material acts as a reservoir for the acid.

Advantageously, the second carrier material is chemically inert with respect to the acid.

The second carrier material may have any suitable shape and size. For example, the second carrier material may be in the form of a sheet or plug.

Advantageously, the shape and size of the second carrier material is similar to the shape and size of the second compartment of the cartridge of the cartridge assembly.

The shape, size, density and porosity of the second carrier material may be chosen to allow the second carrier material to be impregnated with a desired amount of acid.

Advantageously, the acid source is a lactic acid source comprising a second carrier material impregnated with between about 2 milligrams and about 60 milligrams of lactic acid.

Preferably, the lactic acid source comprises a second carrier material impregnated with between about 5 milligrams and about 50 milligrams of lactic acid. More preferably, the lactic acid source comprises a second carrier material impregnated with between about 8 milligrams and about 40 milligrams of lactic acid. Most preferably, the lactic acid source comprises a second carrier material impregnated with between about 10 milligrams and about 30 milligrams of lactic acid.

The shape and dimensions of the first compartment of the cartridge of the cartridge assembly may be chosen to allow a desired amount of nicotine to be housed in the cartridge.

The shape and dimensions of the second compartment of the cartridge of the cartridge assembly may be chosen to allow a desired amount of acid to be housed in the cartridge.

The ratio of nicotine and acid required to achieve an appropriate reaction stoichiometry may be controlled and balanced through variation of the volume of the first compartment of the cartridge of the cartridge assembly relative to the volume of the second compartment of the cartridge of the cartridge assembly.

The first air inlet of the first compartment of the cartridge and the second air inlet of the second compartment of the cartridge may each comprise one or more apertures. For example, the first air inlet of the first compartment of the cartridge and the second air inlet of the second compartment of the cartridge may each comprise one, two, three, four, five, six or seven apertures.

The first air inlet of the first compartment of the cartridge and the second air inlet of the second compartment of the cartridge may comprise the same or different numbers of apertures.

Advantageously, the first air inlet of the first compartment of the cartridge and the second air inlet of the second compartment of the cartridge each comprise a plurality of apertures. For example, the first air inlet of the first compartment of the cartridge and the second air inlet of the second compartment of the cartridge may each comprise two, three, four, five, six or seven apertures.

Providing a first compartment having a first air inlet comprising a plurality of apertures and a second compartment having a second air inlet comprising a plurality of apertures may advantageously result in more homogeneous airflow within the first compartment and the second compartment, respectively. In embodiments in which the cartridge comprises a nicotine source within the first compartment and an acid source within the second compartment, this may improve entrainment of nicotine in an air stream drawn through the first compartment and improve entrainment of acid in an air stream drawn through the second compartment when the mouthpiece body portion of the mouthpiece is in the second position relative to the cartridge.

In embodiments in which the cartridge comprises a nicotine source within the first compartment and an acid source within the second compartment, the ratio of nicotine and acid required to achieve an appropriate reaction stoichiometry may be controlled and balanced through variation of the volumetric airflow through the first compartment of the cartridge relative to the volumetric airflow through the second compartment of the cartridge. The ratio of the volumetric airflow through the first compartment relative to the volumetric airflow through the second compartment may be controlled through variation of one or more of the number, dimensions and location of the apertures forming the first air inlet of the first compartment of the cartridge relative to the number, dimensions and location of the apertures forming the second air inlet of the second compartment of the cartridge.

In embodiments in which the acid source comprises lactic acid, advantageously the flow area of the second air inlet of the second compartment of the cartridge is greater than the flow area of the first air inlet of the first compartment of the cartridge.

As used herein with reference to the invention, the term “flow area” is used to describe the cross-sectional area of an air inlet or air outlet through which air flows during use. In embodiments in which an air inlet or air outlet comprises a plurality of apertures, the flow area of the air inlet or air outlet is the total flow area of the air inlet or air outlet and is equal to the sum of the flow areas of each of the plurality of apertures forming the air inlet or air outlet. In embodiments in which the cross-sectional area of an air inlet or air outlet varies in the direction of airflow, the flow area of the air inlet or air outlet is the minimum cross-sectional area in the direction of airflow.

Increasing the flow area of the second air inlet of the second compartment of the cartridge relative to the flow area of the first air inlet of the first compartment of the cartridge advantageously increases the volumetric airflow through the second air inlet compared to the volumetric airflow through the first air inlet.

In embodiments in which the acid source comprises lactic acid, preferably the ratio of the flow area of the first air inlet of the first compartment of the cartridge to the flow area of the second air inlet of the second compartment of the cartridge is between about 3:4 and about 1:2. More preferably, the ratio of the flow area of the first air inlet of the first compartment of the cartridge to the flow area of the second air inlet of the second compartment of the cartridge is between about 2:3 and about 1:2.

The flow area of the second air inlet of the second compartment of the cartridge may be increased relative to the flow area of the first air inlet of the first compartment of the cartridge by one or both of increasing the size of the one or more apertures forming the second air inlet relative to the size of the one or more apertures forming the first air inlet and increasing the number of apertures forming the second air inlet relative to the number of apertures forming the first air inlet.

Advantageously, the flow area of the second air inlet of the second compartment of the cartridge is increased relative to the flow area of the first air inlet of the first compartment of the cartridge by increasing the number of apertures forming the second air inlet relative to the number of apertures forming the first air inlet.

Advantageously, the first air inlet of the first compartment of the cartridge comprises between 2 and 5 apertures.

Advantageously, the second air inlet of the second compartment of the cartridge comprises between 3 and 7 apertures.

Advantageously, the flow area of the first air inlet of the first compartment of the cartridge is between about 0.1 square millimetres and about 1.6 square millimetres, more advantageously between about 0.2 square millimetres and about 0.8 square millimetres.

In embodiments in which the first air inlet of the first compartment of the cartridge comprises a plurality of apertures, the apertures may have different flow areas so that the flow area of the first air inlet of the first compartment of the cartridge is divided unequally between the apertures forming the first air inlet.

In embodiments in which the first air inlet of the first compartment of the cartridge comprises a plurality of apertures, each of the apertures may have the same flow area so that the flow area of the first air inlet of the first compartment of the cartridge is divided equally between the apertures forming the first air inlet. Providing a first compartment having a first air inlet comprising a plurality of apertures having substantially the same flow area may advantageously simplify manufacturing of the cartridge.

The first air inlet of the first compartment of the cartridge may comprise one or more apertures having any suitable cross-sectional shape. For example, the cross-sectional shape of each aperture may be circular, elliptical, square or rectangular. Advantageously, each aperture has a substantially circular cross-sectional shape. Advantageously, the diameter of each aperture is between about 0.2 millimetres and about 0.6 millimetres.

In embodiments in which the acid source comprises lactic acid, advantageously the flow area of the second air inlet of the second compartment of the cartridge is between about 0.2 square millimetres and about 2.4 square millimetres, more advantageously between about 0.4 square millimetres and about 1.2 square millimetres.

In embodiments in which the second air inlet of the second compartment of the cartridge comprises a plurality of apertures, the apertures may have different flow areas so that the total flow area of the second air inlet of the second compartment of the cartridge is divided unequally between the apertures forming the second air inlet.

In embodiments in which the second air inlet of the second compartment of the cartridge comprises a plurality of apertures, each of the apertures may have the same flow area so that the total flow area of the second air inlet of the second compartment of the cartridge is divided equally between the apertures forming the second air inlet. Providing a second compartment having a second air inlet comprising a plurality of apertures having substantially the same flow area may advantageously simplify manufacturing of the cartridge.

The second air inlet of the second compartment of the cartridge may comprise one or more apertures having any suitable cross-sectional shape. For example, the cross-sectional shape of each aperture may be circular, elliptical, square or rectangular. Advantageously, each aperture has a substantially circular cross-sectional shape. Advantageously, the diameter of each aperture is between about 0.2 millimetres and about 0.6 millimetres.

The first air outlet of the first compartment of the cartridge and the second air outlet of the second compartment of the cartridge may each comprise one or more apertures. For example, the first air outlet of the first compartment of the cartridge and the second air outlet of the second compartment of the cartridge may each comprise one, two, three, four, five, six or seven apertures.

The first air outlet of the first compartment of the cartridge and the second air outlet of the second compartment of the cartridge may comprise the same or different numbers of apertures.

Advantageously, the first air outlet of the first compartment of the cartridge and the second air outlet of the second compartment of the cartridge may each comprise a plurality of apertures. For example, the first air outlet of the first compartment of the cartridge and the second air outlet of the second compartment of the cartridge may each comprise two, three, four, five, six or seven apertures. Providing a first compartment having a first air outlet comprising a plurality of apertures and a second compartment having a second air outlet comprising a plurality of apertures may advantageously result in more homogeneous airflow within the first compartment and the second compartment, respectively. In embodiments in which the cartridge comprises a nicotine source within the first compartment and an acid source within the second compartment, this may improve entrainment of nicotine in an air stream drawn through the first compartment and improve entrainment of acid in an air stream drawn through the second compartment when the mouthpiece body portion of the mouthpiece is in the second position relative to the cartridge.

In embodiments in which the first air outlet of the first compartment of the cartridge comprises a plurality of apertures, advantageously the first air outlet comprises between 2 and 5 apertures.

In embodiments in which the second air outlet of the second compartment of the cartridge comprises a plurality of apertures, advantageously, the second air outlet comprises between 3 and 7 apertures.

Advantageously, the first air outlet of the first compartment of the cartridge and the second air outlet of the second compartment of the cartridge may each comprise a single aperture. Providing a first compartment having a first air outlet comprising a single aperture and a second compartment having a second air outlet comprising a single aperture may advantageously simplify manufacturing of the cartridge.

In embodiments in which the cartridge comprises a nicotine source within the first compartment and an acid source within the second compartment, the ratio of nicotine and acid required to achieve an appropriate reaction stoichiometry may be controlled and balanced through variation of the volumetric airflow through the first compartment of the cartridge relative to the volumetric airflow through the second compartment of the cartridge. The ratio of the volumetric airflow through the first compartment relative to the volumetric airflow through the second compartment may be controlled through variation of one or more of the number, dimensions and location of the apertures forming the first air outlet of the first compartment of the cartridge relative to the number, dimensions and location of the apertures forming the second air outlet of the second compartment of the cartridge.

The flow area of the first air outlet of the first compartment may be the same as or different to the flow area of the second air outlet of the second compartment.

The flow area of the second air outlet of the second compartment of the cartridge may be greater than flow area of the first air outlet of the first compartment of the cartridge.

Increasing the flow area of the second air outlet of the second compartment of the cartridge relative to the flow area of the first air outlet of the first compartment of the cartridge may advantageously increase the volumetric airflow through the second air outlet compared to the volumetric airflow through the first air outlet.

In embodiments in which the acid source comprises lactic acid, the ratio of the flow area of the first air outlet of the first compartment of the cartridge to the flow area of the second air outlet of the second compartment of the cartridge is preferably between about 3:4 and about 1:2. More preferably, the ratio of the flow area of the first air outlet of the first compartment of the cartridge to the flow area of the second air outlet of the second compartment of the cartridge is between about 2:3 and about 1:2.

In embodiments in which the flow area of the second air outlet of the second compartment of the cartridge is greater than flow area of the first air outlet of the first compartment of the cartridge, the flow area of the second air outlet of the second compartment of the cartridge may be increased relative to the flow area of the first air outlet of the first compartment of the cartridge by one or both of increasing the size of the one or more apertures forming the second air outlet relative to the size of the one or more apertures forming the first air outlet and increasing the number of apertures forming the second air outlet relative to the number of apertures forming the first air outlet.

Advantageously, the flow area of the second air outlet of the second compartment of the cartridge is increased relative to the flow area of the first air outlet of the first compartment of the cartridge by increasing the number of apertures forming the second air outlet relative to the number of apertures forming the first air outlet.

The first air inlet and the first air outlet of the first compartment of the cartridge may comprise the same or different numbers of apertures.

Advantageously, the first air inlet and the first air outlet of the first compartment of the cartridge comprise the same numbers of apertures. Providing a first compartment having a first air inlet and a first air outlet comprising the same number of apertures may advantageously simplify manufacturing of the cartridge.

The second air inlet and the second air outlet of the second compartment of the cartridge may comprise the same or different numbers of apertures.

Advantageously, the second air inlet and the second air outlet of the second compartment of the cartridge comprise the same numbers of apertures. Providing a second compartment having a second air inlet and a second air outlet comprising the same number of apertures may advantageously simplify manufacturing of the cartridge.

Advantageously, the flow area of the first air outlet of the first compartment of the cartridge is between about 0.1 square millimetres and about 5 square millimetres.

In embodiments in which the first air outlet of the first compartment of the cartridge comprises a plurality of apertures, the apertures may have different flow areas so that the flow area of the first air outlet of the first compartment of the cartridge is divided unequally between the apertures forming the first air outlet.

In embodiments in which the first air outlet of the first compartment of the cartridge comprises a plurality of apertures, each of the apertures may have the same flow area so that the flow area of the first air outlet of the first compartment of the cartridge is divided equally between the apertures forming the first air outlet. Providing a first compartment having a first air outlet comprising a plurality of apertures having substantially the same flow area may advantageously simplify manufacturing of the cartridge.

The first air outlet of the first compartment of the cartridge may comprise one or more apertures having any suitable cross-sectional shape. For example, the cross-sectional shape of each aperture may be circular, elliptical, square or rectangular. In embodiments in which the first air outlet of the first compartment of the cartridge comprises a plurality of apertures, advantageously each aperture has a substantially circular cross-sectional shape. In such embodiments, advantageously the diameter of each aperture is between about 0.2 millimetres and about 0.6 millimetres.

The dimensions of the one or more apertures forming the first air inlet of the first compartment of the cartridge may be the same as or different to the dimensions of the one or more apertures forming the first air outlet of the first compartment of the cartridge.

Advantageously, the dimensions of the one or more apertures forming the first air inlet of the first compartment of the cartridge may be substantially the same as the dimensions of the one or more apertures forming the first air outlet of the first compartment of the cartridge. Providing a first compartment having a first air inlet and a first air outlet comprising one or more apertures of substantially the same dimensions may advantageously simplify manufacturing of the cartridge.

Advantageously, the dimensions of the one or more apertures forming the first air outlet of the first compartment of the cartridge may be greater than the dimensions of the one or more apertures forming the first air inlet of the first compartment of the cartridge. Increasing the dimensions of the apertures forming the first air outlet of the first compartment of the cartridge relative to the dimensions of the apertures forming the first air inlet of the first compartment of the cartridge may advantageously reduce the risk of the first air outlet of the first compartment of the cartridge becoming obstructed by, for example, dust.

Advantageously, the flow area of the second air outlet of the second compartment of the cartridge is between about 0.1 square millimetres and about 5 square millimetres.

In embodiments in which the second air outlet of the second compartment of the cartridge comprises a plurality of apertures, the apertures may have different flow areas so that the total flow area of the second air outlet of the second compartment of the cartridge is divided unequally between the apertures forming the second air outlet.

In embodiments in which the second air outlet of the second compartment of the cartridge comprises a plurality of apertures, each of the apertures may have the same flow area so that the total flow area of the second air outlet of the second compartment of the cartridge is divided equally between the apertures forming the second air outlet. Providing a second compartment having a second air outlet comprising a plurality of apertures having substantially the same flow area may advantageously simplify manufacturing of the cartridge.

The second air outlet of the second compartment of the cartridge may comprise one or more apertures having any suitable cross-sectional shape. For example, the cross-sectional shape of each aperture may be circular, elliptical, square or rectangular. In embodiments in which the second air outlet of the second compartment of the cartridge comprises a plurality of apertures, advantageously each aperture has a substantially circular cross-sectional shape. In such embodiments, advantageously the diameter of each aperture is between about 0.2 millimetres and about 0.6 millimetres.

The dimensions of the one or more apertures forming the second air inlet of the second compartment of the cartridge may be the same as or different to the dimensions of the one or more apertures forming the second air outlet of the second compartment of the cartridge.

Advantageously, the dimensions of the one or more apertures forming the second air inlet of the second compartment of the cartridge may be substantially the same as the dimensions of the one or more apertures forming the second air outlet of the second compartment of the cartridge. Providing a second compartment having a second air inlet and a second air outlet comprising one or more apertures of substantially the same dimensions may advantageously simplify manufacturing of the cartridge.

Advantageously, the dimensions of the one or more apertures forming the second air outlet of the second compartment of the cartridge may be greater than the dimensions of the one or more apertures forming the second air inlet of the second compartment of the cartridge. Increasing the dimensions of the apertures forming the second air outlet of the second compartment of the cartridge relative to the dimensions of the apertures forming the second air inlet of the second compartment of the cartridge may advantageously reduce the risk of the second air outlet of the second compartment of the cartridge becoming obstructed by, for example, dust.

In embodiments in which the cartridge comprises a nicotine source within the first compartment and an acid source within the second compartment, nicotine vapour released from the nicotine source in the first compartment of the cartridge and acid vapour released from the acid source in the second compartment of the cartridge may react with one another in the gas phase in the mouthpiece to form an aerosol of nicotine salt particles.

The first compartment and the second compartment may be arranged symmetrically with respect to each other within the cartridge.

Advantageously, the cartridge is an elongate cartridge. In embodiments in which the cartridge is an elongate cartridge, the first compartment and the second compartment of the cartridge may be arranged symmetrically about the longitudinal axis of the cartridge.

The cartridge may have any suitable transverse cross-sectional shape. For example, the transverse cross-sectional shape of the cartridge may be circular, semi-circular, elliptical, triangular, square, rectangular or trapezoidal.

The cartridge may have any suitable size.

For example, the cartridge may have a length of between about 5 millimetres and about 50 millimetres. Advantageously, the cartridge may have a length between about 10 millimetres and about 20 millimetres.

For example, the cartridge may have a width of between about 4 millimetres and about 10 millimetres and a height of between about 4 millimetres and about 10 millimetres. Advantageously, the cartridge may have a width of between about 6 millimetres and about 8 millimetres and a height of between about 6 millimetres and about 8 millimetres.

The removable first seal may be formed from any suitable material or combination of materials. Suitable materials include, but are not limited to: metal foils, such as, for example, aluminium foil; metal foil laminates; metallised films; thermoplastic polymers, such as, for example, polyethylene, polypropylene and polyethylene terephthalate; and plastic-coated papers.

The removable first seal may be secured to the upstream end of the cartridge by any suitable means. Suitable means include, but are not limited to, adhesive bonding, thermal bonding, such as for example, laser bonding and ultrasonic welding, and combinations thereof.

The removable first seal may be provided with a pull tab to facilitate removal of the removable first seal by a user prior to use of the cartridge assembly.

The cartridge of the cartridge assembly may comprise a cartridge body portion defining the at least one compartment and a cartridge housing portion defining a cartridge cavity, wherein at least a downstream end portion of the cartridge body portion is secured within an upstream end portion of the cartridge cavity and wherein the cartridge actuation portion is on an inner surface of a downstream end portion of the cartridge cavity.

The cartridge body portion and the cartridge housing portion may be integrally formed as a single piece.

The cartridge body portion and the cartridge housing portion may be formed as separate components.

In such embodiments, the cartridge body portion may be removably secured or permanently secured within the upstream end portion of the cartridge cavity.

The cartridge body portion may be secured within the upstream end portion of the cartridge cavity by any suitable means. Suitable means include, but are not limited to: mechanical connection, such as, for example, threaded connection, press-fit connection and snap-fit connection; adhesive bonding; and thermal bonding, such as for example, laser welding and ultrasonic welding.

For example, the cartridge body portion may comprise a female snap-fit connector and the cartridge housing portion may comprise a male snap-fit connector that is configured to mate with the female snap-fit connector of the cartridge body portion in order to secure at least a downstream end portion of the cartridge body portion within an upstream end portion of the cartridge cavity.

In embodiments in which the cartridge of the cartridge assembly comprises a cartridge body portion and a cartridge housing portion, an outer surface of the cartridge housing portion may form a transversely outermost surface of the cartridge.

In embodiments in which the cartridge of the cartridge assembly comprises a cartridge body portion and a cartridge housing portion, the removable first seal may be secured to one or both of an upstream end of the cartridge body portion and an upstream end of the cartridge housing portion.

In embodiments in which the cartridge of the cartridge assembly comprises a cartridge body portion and a cartridge housing portion, the air outlet of the at least one compartment of the cartridge may be at a downstream end of the cartridge body portion and the mouthpiece body portion of the mouthpiece may be moveable with respect to the cartridge from a first position in which the second seal abuts the downstream end of the cartridge body portion to a second position in which the second seal is spaced apart the downstream end of the cartridge body portion.

The cartridge may be formed from any suitable material or combination of materials. Suitable materials include, but are not limited to, aluminium, steel, polyether ether ketone (PEEK), polyimides, such as Kapton®, polyethylene terephthalate (PET), polyethylene (PE), high-density polyethylene (HDPE), polypropylene (PP), polystyrene (PS), fluorinated ethylene propylene (FEP), polytetrafluoroethylene (PTFE), polyoxymethylene (POM), epoxy resins, polyurethane resins, vinyl resins, liquid crystal polymers (LCP) and modified LCPs, such as LCPs with graphite or glass fibres.

In embodiments in which the cartridge of the cartridge assembly comprises a cartridge body portion and a cartridge housing portion, the cartridge body portion and the cartridge housing portion may be formed from the same or different materials.

In embodiments in which the cartridge of the cartridge assembly comprises a first compartment containing a nicotine source and a second compartment containing an acid source, the cartridge may be formed from one or more materials that are nicotine-resistant and acid-resistant.

In embodiments in which the cartridge of the cartridge assembly comprises a first compartment containing a nicotine source and a second compartment containing an acid source, the first compartment of the cartridge may be coated with one or more nicotine-resistant materials and the second compartment of the cartridge may be coated with one or more acid-resistant materials.

Examples of suitable nicotine-resistant materials and acid-resistant materials include, but are not limited to, polyethylene (PE), polypropylene (PP), polystyrene (PS), fluorinated ethylene propylene (FEP), polytetrafluoroethylene (PTFE), epoxy resins, polyurethane resins, vinyl resins and combinations thereof.

Use of one or more nicotine-resistant materials to one or both of form the cartridge and coat the interior of the first compartment of the cartridge may advantageously enhance the shelf life of the cartridge.

Use of one or more acid-resistant materials to one or both of form the cartridge and coat the interior of the second compartment of the cartridge may advantageously enhance the shelf life of the cartridge.

The cartridge assembly may comprise a heating element configured to heat the at least one compartment of the cartridge.

In such embodiments, the cartridge assembly may be configured for use with an aerosol-generating device configured to supply power to the heating element of the cartridge.

The heating element may be an electrical heating element. The heating element may comprise a resistive heating element.

Advantageously, the heating element is configured to heat the at least one compartment to a temperature of below about 250 degrees Celsius. Preferably, the heating element is configured to heat the at least one compartment to a temperature of between about 80 degrees Celsius and about 150 degrees Celsius.

In embodiments in which the cartridge comprises a first compartment and a second compartment, the heating element is preferably configured to heat both the first compartment and the second compartment of the cartridge. In such embodiments, the heating element is advantageously located between the first compartment and the second compartment of the cartridge. That is the first compartment and the second compartment are disposed on either side of the heating element.

In embodiments in which the cartridge comprises a first compartment and a second compartment, the heating element of the cartridge assembly may be configured to heat the first compartment and the second compartment of the cartridge to substantially the same temperature.

As used herein with reference to the invention, by “substantially the same temperature” it is meant that the difference in temperature between the first compartment and the second compartment of the cartridge measured at corresponding locations relative to the heating element is less than about 3° C.

In use, heating the at least one compartment of the cartridge to a temperature above ambient temperature advantageously enables control of the vapour concentration of the contents of the at least one compartment.

In embodiments in which the cartridge of the cartridge assembly comprises a first compartment containing a nicotine source and a second compartment containing an acid source, heating the first compartment and the second compartment of the cartridge to a temperature above ambient temperature advantageously enables the vapour concentrations of the nicotine in the first compartment of the cartridge and the vapour pressure of acid in the second compartment of the cartridge to be controlled and balanced proportionally to yield an efficient reaction stoichiometry between the nicotine and the acid. Advantageously, this may improve the efficiency of the formation of nicotine salt particles and the consistency of delivery to a user. Advantageously, it may also reduce the delivery of unreacted nicotine and unreacted acid to a user.

Advantageously, the cartridge of the cartridge assembly may comprise a heater compartment for receiving a heating element of an aerosol-generating device. In use, a heating element of an aerosol-generating device is received within the heater compartment to heat the at least one compartment of the cartridge of the cartridge assembly.

Advantageously, the heater compartment extends from the upstream end of the cartridge at least part way along the length of the cartridge.

Advantageously, the heating element compartment extends along the longitudinal axis of the cartridge.

The heater compartment may extend from the upstream end of the cartridge to the downstream end of the cartridge. In such embodiments, the heater compartment has an open upstream end and an open downstream end.

Advantageously, the heater compartment may extend from the upstream end of the cartridge part way along the length of the cartridge. In such embodiments, the heater compartment has an open upstream end and a closed downstream end.

In embodiments in which the cartridge of the cartridge assembly comprises a first compartment and a second compartment, the heater compartment is advantageously located between the first compartment and the second compartment. That is, the first compartment and the second compartment are disposed on either side of the heater compartment.

Advantageously, the cartridge of the cartridge assembly may comprise a susceptor for inductively heating the at least one compartment of the cartridge.

In such embodiments, during use, an inductive heating element generates an alternating magnetic field to generate eddy currents and hysteresis losses in the susceptor, causing the susceptor to heat up, thereby heating the at least one compartment of the cartridge.

In embodiments in which the cartridge of the cartridge assembly comprises a first compartment and a second compartment, the susceptor is advantageously located between the first compartment and the second compartment. That is, the first compartment and the second compartment are disposed on either side of the susceptor.

The cartridge of the cartridge assembly may be formed from one or more thermally conductive materials.

The at least one compartment of the cartridge may be coated with one or more thermally conductive materials.

Use of one or more thermally conductive materials to one or both of form the cartridge and coat the interior of the at least one compartment of the cartridge may advantageously increase heat transfer from a heating element or a susceptor to the contents of the at least one compartment of the cartridge.

In embodiments in which the cartridge of the cartridge assembly comprises a first compartment containing a nicotine source and a second compartment containing an acid source, use of one or more thermally conductive materials to one or both of form the cartridge and coat the interior of the first compartment and the second compartment of the cartridge may advantageously increase heat transfer from a heating element or a susceptor to the nicotine source and the acid source.

Suitable thermally conductive materials include, but are not limited to, metals such as, for example, aluminium, chromium, copper, gold, iron, nickel and silver, alloys, such as brass and steel and combinations thereof.

The cartridge of the cartridge assembly may be formed of one or more materials having a low resistivity or a high resistivity depending on whether the at least one compartment of the cartridge is heated by conduction or induction.

The at least one compartment of the cartridge of the cartridge assembly may be coated with one or more materials having a low resistivity or a high resistivity depending on whether the at least one compartment of the cartridge is heated by conduction or induction.

In embodiments in which the cartridge of the cartridge assembly comprises a first compartment and a second compartment, the first compartment and the second compartment of the cartridge may be coated with one or more materials having a low resistivity or a high resistivity depending on whether the first compartment and the second compartment of the cartridge are heated by conduction or induction.

The cartridge of the cartridge assembly may be formed by any suitable method. Suitable methods include, but are not limited to, deep drawing, injection moulding, blistering, blow forming and extrusion.

The mouthpiece of the cartridge assembly may comprise one or more aerosol-modifying agents. For example, the mouthpiece body portion of the mouthpiece of the cartridge assembly may contain one or more sorbents, one or more flavourants, one or more chemesthetic agents or a combination thereof.

The mouthpiece of the cartridge assembly may comprise a mouthpiece housing portion defining a mouthpiece cavity, wherein the mouthpiece body portion is secured within a downstream end portion of the mouthpiece cavity and wherein at least a downstream end portion of the cartridge is received in an upstream end portion of the mouthpiece cavity.

The mouthpiece body portion and the mouthpiece housing portion may be integrally formed as a single piece.

The mouthpiece body portion and the mouthpiece housing portion may be formed as separate components.

In such embodiments, the mouthpiece body portion may be removably secured or permanently secured within a downstream end portion of the mouthpiece cavity.

The mouthpiece may be secured within the downstream end portion of the mouthpiece cavity by any suitable means. Suitable means include, but are not limited to: mechanical connection, such as, for example, threaded connection, press-fit connection and snap-fit connection; adhesive bonding; and thermal bonding, such as for example, laser welding and ultrasonic welding.

For example, the mouthpiece body portion may comprise a female snap-fit connector and the mouthpiece housing portion may comprise a male snap-fit connector that is configured to mate with the female snap-fit connector of the mouthpiece body portion in order to secure the mouthpiece body portion within a downstream end portion of the mouthpiece cavity.

In embodiments in which the mouthpiece of the cartridge assembly comprises a mouthpiece body portion and a mouthpiece housing portion, the mouthpiece actuation portion provided on an outer surface of the mouthpiece body portion is not provided on a transversely outermost surface of the mouthpiece.

In embodiments in which the mouthpiece of the cartridge assembly comprises a mouthpiece body portion and a mouthpiece housing portion, an outer surface of the mouthpiece housing portion may form a transversely outermost surface of the mouthpiece.

The mouthpiece body portion of the mouthpiece of the cartridge assembly may be formed from any suitable material or combination of materials. Suitable materials include, but are not limited to, aluminium, steel, polyether ether ketone (PEEK), polyimides, such as Kapton®, polyethylene terephthalate (PET), polyethylene (PE), high-density polyethylene (HDPE), polypropylene (PP), polystyrene (PS), fluorinated ethylene propylene (FEP), polytetrafluoroethylene (PTFE), polyoxymethylene (POM), epoxy resins, polyurethane resins, vinyl resins, liquid crystal polymers (LCP) and modified LCPs, such as LCPs with graphite or glass fibres.

In embodiments in which the mouthpiece of the cartridge assembly comprises a mouthpiece body portion and a mouthpiece housing portion, the mouthpiece body portion and the mouthpiece housing portion may be formed from the same or different materials.

The mouthpiece body portion of the mouthpiece of the cartridge assembly may be formed by any suitable method. Suitable methods include, but are not limited to: deep drawing; injection moulding; blistering; blow forming; extrusion; subtractive methods, such as, for example, machining; and additive methods, such as, for example, fused deposition modelling and stereolithography.

In embodiments in which the mouthpiece of the cartridge assembly comprises a mouthpiece body portion and a mouthpiece housing portion, the mouthpiece body portion and the mouthpiece housing portion may be formed by the same or different methods.

The second seal at the upstream end of the mouthpiece body portion of the mouthpiece of the cartridge assembly may be formed from any suitable material or combination of materials. Suitable materials include, but are not limited to: thermoplastic elastomers (TPE); silicones (polysiloxane); soft polymers, such as polyethylene and polypropylene; natural rubbers; and synthetic rubbers.

The cartridge of the cartridge assembly may be designed to be disposed of once the contents of the at least one compartment are depleted.

For example, in embodiments in which the cartridge of the cartridge assembly comprises a first compartment containing a nicotine source and a second compartment containing an acid source, the cartridge may be designed to be disposed of once the nicotine in the first compartment and the acid in the second compartment of the cartridge are depleted.

In embodiments in which the cartridge comprises a cartridge body portion and a cartridge housing portion, the cartridge body portion and the cartridge housing portion may be designed to be disposed of once the contents of the at least one compartment are depleted.

In embodiments in which the cartridge comprises a cartridge body portion and a cartridge housing portion, the cartridge body portion may be designed to be disposed of once the contents of the at least one compartment are depleted and the cartridge housing portion may be designed to be reusable. In such embodiments, at least a downstream end portion of the cartridge body portion may advantageously be removably secured within an upstream end portion of the cartridge housing portion of the cartridge of the cartridge assembly.

The cartridge of the cartridge assembly may be designed to be refillable.

The mouthpiece of the cartridge assembly may be designed to be disposed of once the contents of the at least one compartment of the cartridge of the cartridge assembly are depleted.

For example, in embodiments in which the cartridge of the cartridge assembly comprises a first compartment containing a nicotine source and a second compartment containing an acid source, the mouthpiece of the cartridge assembly may be designed to be disposed of once the nicotine in the first compartment and the acid in the second compartment of the cartridge are depleted.

The mouthpiece of the cartridge assembly may be designed to be reusable. In embodiments in which the mouthpiece of the cartridge assembly is designed to be reusable, the mouthpiece actuation portion of the mouthpiece body portion of the mouthpiece of the cartridge assembly may advantageously be removably engaged with the cartridge actuation portion of the cartridge of the cartridge assembly.

The cartridge assembly may simulate the shape and dimensions of a combustible smoking article, such as a cigarette, a cigar, or a cigarillo. Advantageously, in such embodiments the cartridge assembly may simulate the shape and dimensions of a cigarette.

The cartridge assembly may be configured for engagement with a device housing of an aerosol-generating device.

According to the invention there is provided an aerosol-generating system comprising: a cartridge assembly according to the invention; and an aerosol-generating device comprising: a device housing defining a device cavity configured to receive at least an upstream end portion of the cartridge of the cartridge assembly; and a heating element for heating the at least one compartment of the cartridge.

Advantageously, the aerosol-generating system comprises a consumable cartridge assembly according to the invention and a reusable aerosol-generating device comprising: a device housing defining a device cavity configured to receive at least an upstream end portion of the cartridge of the cartridge assembly; and a heating element for heating the at least one compartment of the cartridge.

The heating element may be an electrical heating element. The heating element may comprise a resistive heating element.

The heating element may be an inductive heating element. The inductive heating element may comprise an inductor coil. In such embodiments, the inductive heater may advantageously circumscribe at least a portion of the device cavity.

In such embodiments, during use, the inductive heater generates an alternating magnetic field to generate eddy currents and hysteresis losses in a susceptor in the cartridge assembly, causing the susceptor to heat up, thereby heating the at least one compartment of the cartridge.

The heating element may be located within the device cavity of the aerosol-generating device.

Advantageously, the heating element may be located within the device cavity of the aerosol-generating device and the cartridge may comprise a heater compartment for receiving the heating element as described above. In use, the heating element is received within heater compartment of the cartridge and heats the at least one compartment of the cartridge.

In such embodiments, the heating element of the aerosol-generating device may advantageously be an elongate heating element in the form of a heater blade having a width that is greater than the thickness thereof and the heater compartment of the cartridge may be configured as an elongate slot.

The heating element may circumscribe at least a portion of the device cavity.

In such embodiments, the heating element may be arranged to circumscribe at least a portion of the cartridge when at least an upstream end portion of the cartridge of the cartridge assembly is received within the device cavity.

Advantageously, the heating element may be an inductor coil and the cartridge may comprise a susceptor for inductively heating the at least one compartment of the cartridge as described above.

Advantageously, the heating element of the aerosol-generating device is configured to heat the at least one compartment to a temperature of below about 250 degrees Celsius. Preferably, the heating element of the aerosol-generating device is configured to heat the at least one compartment to a temperature of between about 80 degrees Celsius and about 150 degrees Celsius.

In embodiments in which the cartridge of the cartridge assembly comprises a first compartment and a second compartment, the heating element is preferably configured to heat both the first compartment and the second compartment of the cartridge.

In embodiments in which the cartridge of the cartridge assembly comprises a first compartment and a second compartment, the heating element of the aerosol-generating device may be configured to heat the first compartment and the second compartment of the cartridge to substantially the same temperature.

In use, heating the at least one compartment of the cartridge to a temperature above ambient temperature advantageously enables control of the vapour concentration of the contents of the at least one compartment.

In embodiments in which the cartridge of the cartridge assembly comprises a first compartment containing a nicotine source and a second compartment containing an acid source, heating the first compartment and the second compartment of the cartridge to a temperature above ambient temperature advantageously enables the vapour concentrations of the nicotine in the first compartment of the cartridge and the vapour pressure of acid in the second compartment of the cartridge to be controlled and balanced proportionally to yield an efficient reaction stoichiometry between the nicotine and the acid. Advantageously, this may improve the efficiency of the formation of nicotine salt particles and the consistency of delivery to a user. Advantageously, it may also reduce the delivery of unreacted nicotine and unreacted acid to a user.

The aerosol-generating device may further comprise a power supply for supplying power to the heating element and a controller configured to control a supply of power from the power supply to the heating element.

The aerosol-generating device may comprise one or more temperature sensors configured to sense the temperature of the heating element and the at least one compartment.

In such embodiments, the controller may be configured to control a supply of power to the heating element based on a sensed temperature.

The removable first seal of the cartridge of the cartridge assembly is configured to be removed by a user prior to at least an upstream end portion of the cartridge of the cartridge assembly being received in the device cavity of the aerosol-generating device.

Advantageously, the mouthpiece body portion of the mouthpiece of the cartridge assembly may be moveable with respect to the cartridge of the cartridge assembly from the first position to the second position when at least an upstream end portion of the cartridge of the cartridge assembly is received in the device cavity of the aerosol-generating device. This allows a user to move the mouthpiece body portion from the first position to the second position without removing the cartridge of the cartridge assembly from the device cavity of the aerosol-generating device. This facilitates use of the aerosol-generating system by a user.

Advantageously, the mouthpiece body portion of the mouthpiece of the cartridge assembly may be moveable with respect to the cartridge of the cartridge assembly from the second position to the first position when at least an upstream end portion of the cartridge of the cartridge assembly is received in the device cavity of the aerosol-generating device. This allows a user to move the mouthpiece body portion from the second position to the first position without removing the cartridge of the cartridge assembly from the device cavity of the aerosol-generating device. This facilitates multiple uses of the aerosol-generating system by a user.

In embodiments in which the cartridge assembly comprises a mouthpiece comprising a mouthpiece housing, movement of the mouthpiece body portion of the mouthpiece of the cartridge assembly from the first position to the second position may change one or both of the position and the alignment of the mouthpiece housing portion of the mouthpiece of the cartridge assembly relative to the device housing of the aerosol-generating device.

In such embodiments, movement of the mouthpiece body portion of the mouthpiece of the cartridge assembly from the first position to the second position, may change the longitudinal position of the mouthpiece housing portion of the mouthpiece of the cartridge assembly relative to the device housing of the aerosol-generating device. For example, when the mouthpiece body portion of the mouthpiece of the cartridge assembly is in the first position an upstream end of the mouthpiece housing portion of the mouthpiece of the cartridge assembly may abut a downstream end of the device housing of the aerosol-generating device and when the mouthpiece body portion of the mouthpiece of the cartridge assembly is in the second position the upstream end of the mouthpiece housing portion of the mouthpiece of the cartridge assembly may be spaced apart from the downstream end of the device housing of the aerosol-generating device.

In such embodiments, translational and rotational movement of the mouthpiece body portion of the mouthpiece of the cartridge assembly from the first position to the second position, may change the alignment of a projection, indentation or symbol provided on the mouthpiece housing portion of the mouthpiece of the cartridge assembly relative to a projection, indentation or symbol provided on the device housing of the aerosol-generating device. For example, when the mouthpiece body portion of the mouthpiece of the cartridge assembly is in the first position a symbol provided on an outer surface of the mouthpiece housing portion of the mouthpiece of the cartridge assembly may be aligned with a symbol provided on an outer surface of the device housing of the aerosol-generating device and when the mouthpiece body portion of the mouthpiece of the cartridge assembly is in the second position the symbol provided on the outer surface of the mouthpiece housing portion of the mouthpiece of the cartridge assembly may be misaligned with the symbol provided on the outer surface of the downstream end of the device housing of the aerosol-generating device.

In embodiments in which movement of the mouthpiece body portion of the mouthpiece of the cartridge assembly from the first position to the second position changes one or both of the longitudinal position and the alignment of the mouthpiece housing portion of the mouthpiece relative to the device housing of the aerosol-generating device, one or both of the longitudinal position and the alignment of the mouthpiece housing portion of the mouthpiece of the cartridge assembly relative to the device housing of the aerosol-generating device may indicate to a user whether the mouthpiece body portion of the mouthpiece of the cartridge assembly is in the first position or the second position. This facilitates use of the aerosol-generating system by a user.

For the avoidance of doubt, features described above in relation to one aspect of the invention may also be applicable to other aspects of the invention. In particular, features described above in relation to the cartridge assembly of the invention may also relate, where appropriate, to the aerosol-generating systems of the invention, and vice versa.

Embodiments of the invention will now be described, by way of example only, with reference to the accompanying drawings, in which:

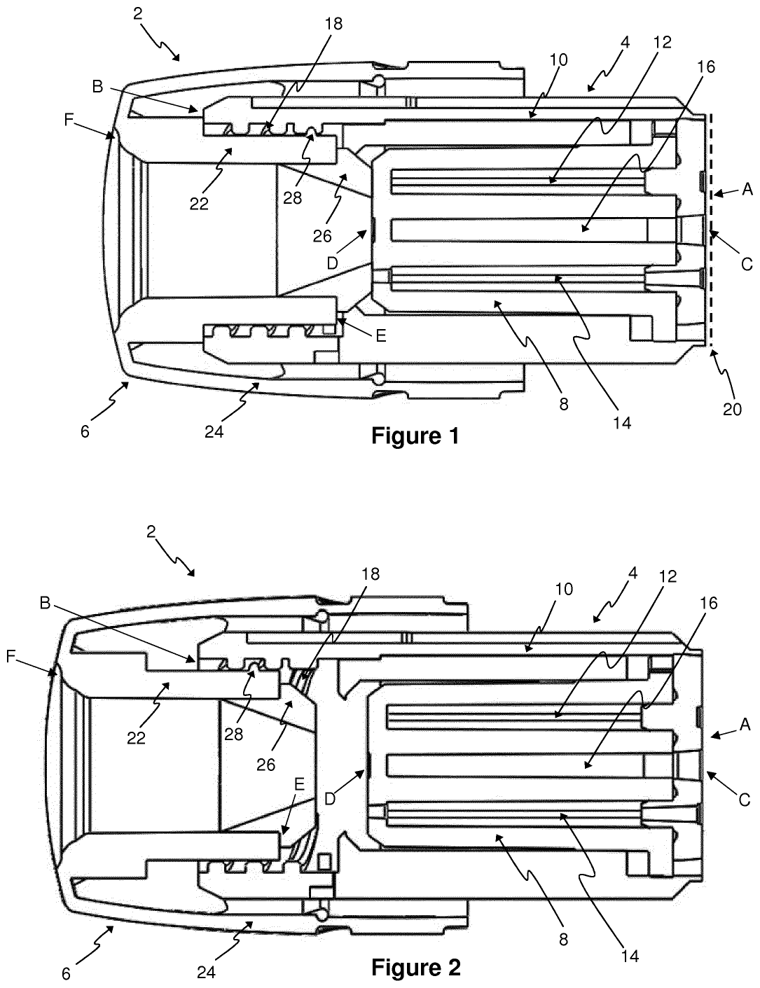

FIG. 1 shows a cross-sectional view of a cartridge assembly according to a first embodiment of the invention in a first position;

FIG. 2 shows a cross-sectional view of the cartridge assembly of FIG. 1 in a second position;

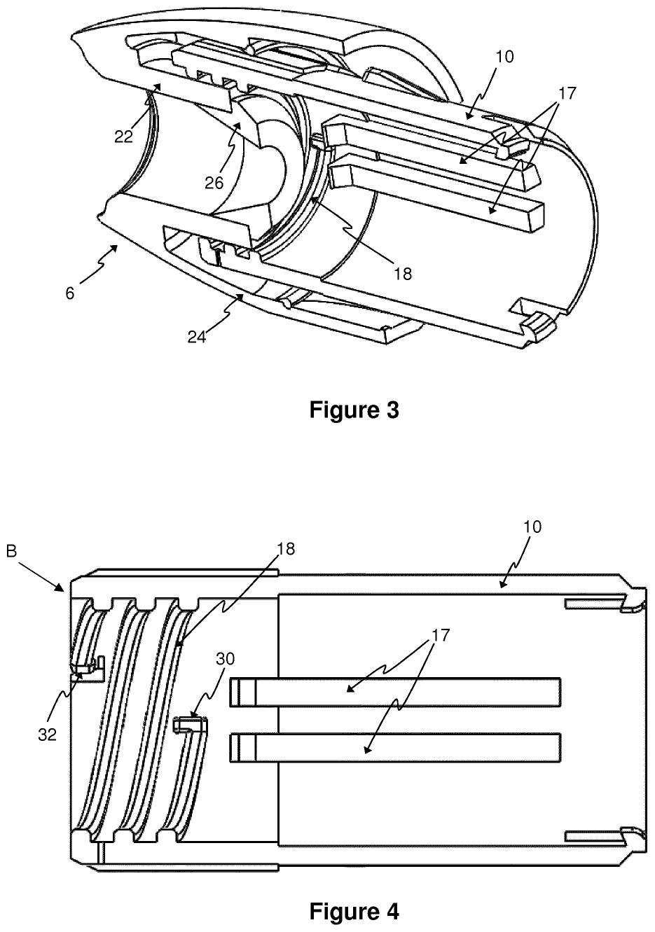

FIG. 3 shows a cross-sectional view of the mouthpiece and the cartridge housing portion of the cartridge of the cartridge assembly of FIG. 1;

FIG. 4 shows a cross-sectional view of the cartridge housing portion of the cartridge of the cartridge assembly of FIG. 1;

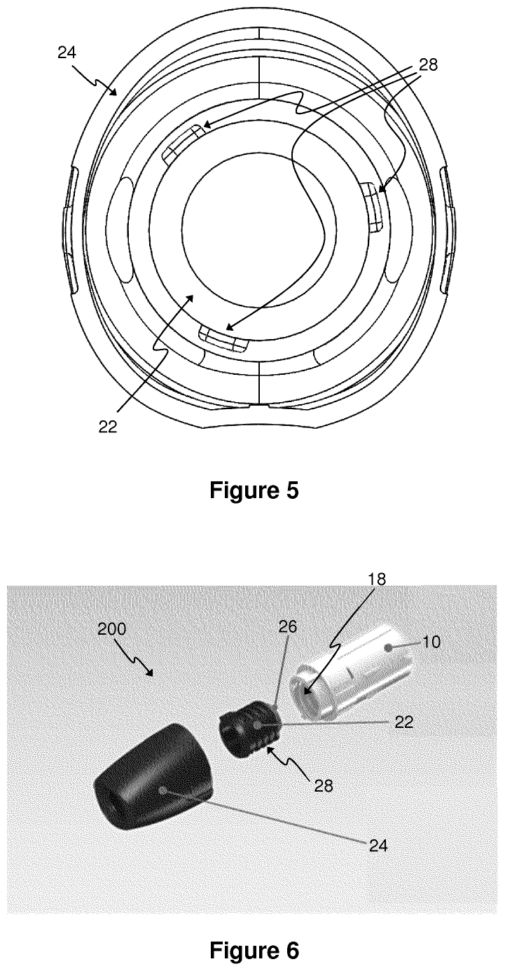

FIG. 5 shows a cross-sectional view of the mouthpiece body portion and mouthpiece housing portion of the mouthpiece of the cartridge assembly of FIG. 1;

FIG. 6 shows an exploded view of a cartridge assembly according to a second embodiment of the invention;

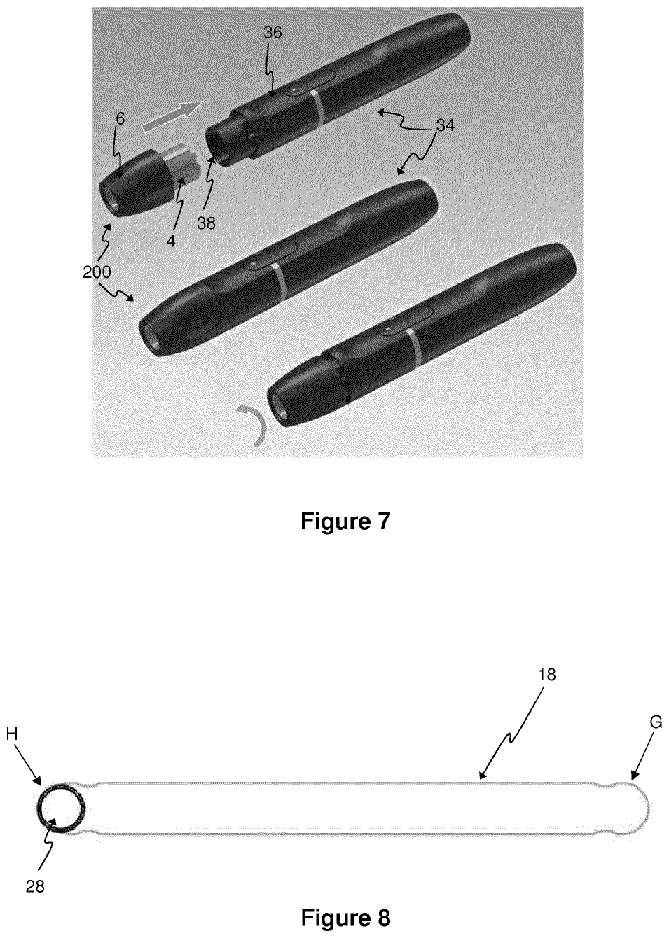

FIG. 7 shows an aerosol-generating system according to an embodiment of the invention comprising the cartridge assembly of FIG. 6 and an aerosol-generating device; and

FIG. 8 shows the cartridge actuation portion and the mouthpiece actuation portion of a cartridge assembly according to a third embodiment of the invention in a first position.

FIG. 1 shows a cross-sectional view of a cartridge assembly 2 according to a first embodiment of the invention for use in an aerosol-generating system for generating an aerosol comprising nicotine salt particles.

The cartridge assembly 2 comprises a cartridge 4 having an upstream end A and a downstream end B and a mouthpiece 6. FIG. 1 shows the cartridge assembly 2 with the mouthpiece 6 in a first position relative to the cartridge 4.

The cartridge 4 comprises a cartridge body portion 8 and a cartridge housing portion 10. The cartridge body portion 8 and the cartridge housing portion 10 are formed as separate components.

The cartridge body portion 8 has a generally cylindrical shape. The cartridge body portion 8 defines a first compartment 12 and a second compartment 14. The first compartment 12 and the second compartment 14 are arranged in parallel within the cartridge body portion 8.

The cartridge body portion 8 also defines a heater compartment 16 located between the first compartment 12 and the second compartment 14.

The first compartment 12 has a first air inlet at the upstream end A of the cartridge 4 and a first air outlet downstream of the first air inlet. The first compartment 12 extends from an upstream end C of the cartridge body portion 8 to a downstream end D of the cartridge body portion 8 and the first air outlet of the first compartment 12 is at the downstream end D of the cartridge body portion 8.

The second compartment 14 has a second air inlet comprising at the upstream end A of the cartridge 4 and a second air outlet downstream of the second air inlet. The second compartment 14 extends from the upstream end C of the cartridge body portion 8 to the downstream end D of the cartridge body portion 8 and the second air outlet of the second compartment 14 is at the downstream end D of the cartridge body portion 8.

The first compartment 12 contains a nicotine source comprising a first carrier material impregnated with nicotine. The second compartment 14 contains an acid source comprising a second carrier material impregnated with an acid, such as lactic acid.

The heater compartment 16 extends from the upstream end C of the cartridge body portion 8 to the downstream end D of the cartridge body portion 8. The heater compartment 16 is configured to receive a heating element of an aerosol-generating device for heating the first compartment 12 and the second compartment 14. In an alternative embodiment (not shown), a susceptor is housed in the heater compartment 16 for heating the first compartment 12 and the second compartment 14 via inductive heating of the susceptor using an inductive heating element of an aerosol-generating device.

The cartridge housing portion 10 has a generally cylindrical shape. The cartridge housing portion 10 defines a cartridge cavity. The cartridge body portion 8 is secured within an upstream end portion of the cartridge cavity by a snap-fit connection. As shown in FIG. 3, longitudinal protrusions 17 are provided on an inner surface of the cartridge housing portion 10 defining the upstream end portion of the cartridge cavity. The longitudinal protrusions 17 engage with the cartridge body portion 8 to facilitate alignment of the cartridge body portion 8 in the cartridge cavity.

As shown in FIG. 4, a cartridge actuation portion 18 comprising a helical guide slot is provided on an inner surface of a downstream end portion of the cartridge housing portion 10.

As also shown in FIG. 4, the cartridge 4 comprises three first mechanical stops 30 and three second mechanical stops 32. The three first mechanical stops 30 are provided at an upstream end of the helical guide slot of the cartridge actuation portion 18 and are spaced-apart at 120 degree intervals around the inner surface of the cartridge housing portion 10. The three second mechanical stops 32 are provided at a downstream end of the helical guide slot of the cartridge actuation portion 18 and are spaced-apart at 120 degree intervals around the inner surface of the cartridge housing portion 10.

The cartridge 4 also comprises a removable first seal 20 (shown by a dashed line in FIG. 1). The removable first seal 20 is secured to the upstream end of the cartridge 4. The removable first seal 20 obstructs the first air inlet of the first compartment 12 and the second air inlet of the second compartment 14. As described further below, the removable first seal 20 is configured to be removed by a user prior to first use of the cartridge assembly 2.

The mouthpiece 6 comprises a mouthpiece body portion 22 having an upstream end E and a downstream end F and a mouthpiece housing portion 24. The mouthpiece body portion 22 and the mouthpiece housing portion 24 are integrally formed as a single piece.

The mouthpiece housing portion 24 defines a mouthpiece cavity. The mouthpiece body portion 22 is secured within a downstream end portion of the mouthpiece cavity.

The mouthpiece body portion 22 has a generally cylindrical shape. The mouthpiece body portion 22 has an air inlet at the upstream end E of the mouthpiece body portion 22 and an air outlet at the downstream end F of the mouthpiece body portion 22.

The mouthpiece comprises a second seal 26 at the upstream end E of the mouthpiece body portion 22. The second seal surrounds the air inlet of the mouthpiece body portion 22.

As shown in FIG. 5, a mouthpiece actuation portion 28 comprising three outwardly projecting pins is provided on an outer surface of an upstream end portion of the mouthpiece body portion 22. The three outwardly projecting pins are spaced-apart at 120 degree intervals around the outer surface of the mouthpiece body portion 22.

The three outwardly projecting pins of the mouthpiece actuation portion 28 are engaged with the helical guide slot of the cartridge actuation portion 18.

In FIG. 1 the mouthpiece 6 is in a first position with respect to the cartridge 4 in which the second seal 26 at the upstream end of the mouthpiece body portion 22 abuts the downstream end of the cartridge body portion 8. In this first position the second seal 26 at the upstream end of the mouthpiece body portion 22 abuts and obstructs the first air outlet of the first compartment 12 at the downstream end of the cartridge body portion 8. In this first position the second seal 26 at the upstream end of the mouthpiece body portion 22 also abuts and obstructs the second air outlet of the second compartment 14 at the downstream end of the cartridge body portion 8.

FIG. 2 shows a cross sectional view of the cartridge assembly 2 of FIG. 1 after the removable first seal 20 secured to the upstream end of the cartridge 4 has been removed and the mouthpiece 6 has been turned through 180 degrees with respect to the cartridge 4. FIG. 2 shows the cartridge assembly 2 with the mouthpiece 6 in a second position relative to the cartridge 4.

The mouthpiece body portion 22 of the mouthpiece 6 exhibits a helicoidal motion with respect to the cartridge 4 when moved from the first position relative to the cartridge 4 shown in FIG. 1 to the second position relative to the cartridge 4 shown in FIG. 2. The engagement between the three outwardly projecting pins of the mouthpiece actuation portion 28 provided on the outer surface of the upstream end portion of the mouthpiece body portion 22 of the mouthpiece 6 and the helical guide slot of the cartridge actuation portion 18 on the inner surface of the downstream end portion of the cartridge housing portion 10, translates the 180 degree rotational motion of the mouthpiece body portion 22 of the mouthpiece 6 to linear motion of the mouthpiece body portion 22 of the mouthpiece 6 relative to the cartridge housing portion 10 of the cartridge 4.

As shown in FIG. 4, the cartridge 4 comprises three first mechanical stops 30 and three second mechanical stops 32. The three first mechanical stops 30 are provided at an upstream end of the helical guide slot of the cartridge actuation portion 18 and are spaced-apart at 120 degree intervals around the inner surface of the cartridge housing portion 10. The three second mechanical stops 32 are provided at a downstream end of the helical guide slot of the cartridge actuation portion 18 and are spaced-apart at 120 degree intervals around the inner surface of the cartridge housing portion 10.

When the mouthpiece 6 is in the second position relative to the cartridge 4, the three first mechanical stops 30 provided at the upstream end of the helical guide slot of the cartridge actuation portion 18 engage the three outwardly projecting pins of the mouthpiece actuation portion 28 provided on the outer surface of the upstream end portion of the mouthpiece body portion 22 of the mouthpiece 6. The engagement of the three first mechanical stops 30 and the three outwardly projecting pins prevents further helicoidal movement of the mouthpiece 6 with respect to the cartridge 4 in a direction away from the first position. The engagement of the three first mechanical stops 30 and the three outwardly projecting pins may produce an audible click to indicate to a user that the mouthpiece body portion has reached the second position.

As shown in FIG. 2, the linear motion of the mouthpiece body portion 22 of the mouthpiece 6 relative to the cartridge housing portion 10 of the cartridge 4 results in the second seal 26 being spaced apart from the downstream end of the cartridge body portion 8 when the mouthpiece 6 is in the second position relative to the cartridge 4.

When the mouthpiece 6 is in the second position relative to the cartridge 4, the second seal 26 is spaced apart from the first air outlet of the first compartment 12 at the downstream end of the cartridge body portion 8 and the first air outlet of the first compartment 12 is in fluid communication with the air inlet of the mouthpiece body portion 22. When the mouthpiece 6 is in the second position relative to the cartridge 4, the second seal 26 is also spaced apart from the second air outlet of the second compartment 14 at the downstream end of the cartridge body portion 8 and the second air outlet of the second compartment 14 is also in fluid communication with the air inlet of the mouthpiece body portion 22.

In use, following removal of the removable first seal 20 secured to the upstream end of the cartridge 4, when the mouthpiece 6 is in the second position relative to the cartridge 4 shown in FIG. 2 airflow pathways are created through the cartridge assembly 2. The airflow pathways extend from the upstream end of the cartridge 4 to the downstream end of the mouthpiece through the first compartment 12 and the second compartment 12 of the cartridge body portion 8, via the first air inlet and the first air outlet and the second air inlet and the second air outlet respectively, and through the mouthpiece body portion 22 via the air inlet and air outlet of the mouthpiece body portion 22.

In use, following removal of the removable first seal 20 secured to the upstream end of the cartridge 4, when the mouthpiece 6 is in the second position relative to the cartridge 4 shown in FIG. 2 a user draws on the downstream end of the mouthpiece 6 to draw a first air stream through the first compartment 12 of the cartridge 4 and a second air stream through the second compartment 14 of the cartridge 4. As the first air stream is drawn through the first compartment 12 of the cartridge 4, nicotine vapour is released from the first carrier material into the first air stream. As the second air stream is drawn through the second compartment 14 of the cartridge 6, acid vapour is released from the second carrier material into the second air stream.

The nicotine vapour in the first air stream and the acid vapour in the second air stream react with one another in the gas phase in the mouthpiece 6 to form an aerosol of nicotine salt particles, which is delivered to the user through the proximal end of the mouthpiece 6 through the air outlet of the mouthpiece body portion 22.

The mouthpiece 6 may be turned through 180 degrees with respect to the cartridge 4 back from the second position relative to the cartridge 4 shown in FIG. 2 to the first position relative to the cartridge 4 shown in FIG. 1. When the mouthpiece 6 is back in the first position relative to the cartridge 4, the second seal 26 at the upstream end of the mouthpiece body portion 22 abuts and obstructs the first air outlet of the first compartment 12 and the second air outlet of the second compartment 14 at the downstream end of the cartridge body portion 8. This may substantially prevent the loss of nicotine vapour from the first compartment 12 and acid vapour from the second compartment 14 of the cartridge 4 when the cartridge assembly 2 is not being used.

When the mouthpiece 6 is in the first position relative to the cartridge 4, the three second mechanical stops 32 provided at the downstream end of the helical guide slot of the cartridge actuation portion 18 engage the three outwardly projecting pins of the mouthpiece actuation portion 28 provided on the outer surface of the upstream end portion of the mouthpiece body portion 22 of the mouthpiece 6. The engagement of the three second mechanical stops 32 and the three outwardly projecting pins prevents further helicoidal movement of the mouthpiece 6 with respect to the cartridge 4 in a direction away from the second position. The engagement of the three second mechanical stops 32 and the three outwardly projecting pins may produce an audible click to indicate to a user that the mouthpiece body portion has reached the first position.

The mouthpiece 6 may be moveable repeatedly between the first position relative to the cartridge 4 shown in FIG. 1 and the second position relative to the cartridge 4 shown in FIG. 2 to facilitate multiple uses of the cartridge assembly 2 by a user.

FIG. 6 shows an exploded view of a cartridge assembly 200 according to a second embodiment of the invention. The cartridge assembly 200 according to the second embodiment of the invention is of similar construction and operation as the cartridge assembly 2 according to the first embodiment of the invention shown in FIGS. 1-5. Like reference numerals are used in FIG. 6 and FIGS. 1-5 to designate like parts.

Like the cartridge assembly 2 shown in FIGS. 1-5, the cartridge assembly 200 shown in FIG. 6 comprises a cartridge 4 comprising a cartridge body portion 8 (not visible in FIG. 6), a cartridge housing portion 10 and a removable first seal 20 (not visible in FIG. 6). Like the cartridge assembly 2 shown in FIGS. 1-5, the cartridge assembly 200 shown in FIG. 6 also comprises a mouthpiece 6 comprising a mouthpiece body portion 22, a mouthpiece housing portion 24 and a second seal 26. However, in the cartridge assembly 200 shown in FIG. 6 the mouthpiece body portion 22 and the mouthpiece housing portion 24 are formed as separate components and the mouthpiece body portion 22 is secured within a downstream end portion of the mouthpiece cavity defined by the mouthpiece housing portion 24 by a snap-fit connection.

As shown in FIG. 6, in the cartridge assembly 200 according to the second embodiment of the invention the cartridge actuation portion 18 comprises a first helical thread provided on an inner surface of a downstream end portion of the cartridge housing portion 10 and the mouthpiece actuation portion 28 comprises a second helical thread provided on an outer surface of an upstream end portion of the mouthpiece element 22. Upon assembly of the cartridge assembly 200, the second helical thread of the mouthpiece actuation portion 28 is engaged with the first helical thread of the cartridge actuation portion 18.

The first helical thread of the cartridge actuation portion 18 and the second helical thread of the mouthpiece actuation portion 28 of the cartridge assembly 200 according to the second embodiment of the invention are configured for two-way helicoidal movement of the mouthpiece body portion 22 with respect to the cartridge 4. The mouthpiece 6 may be turned through 90 degrees with respect to the cartridge 4 in opposite directions to effect helicoidal movement of the mouthpiece body portion 22 between a first position relative to the cartridge 4, in which the second seal 26 at the upstream end of the mouthpiece body portion 22 abuts and obstructs the first air outlet of the first compartment 12 and the second air outlet of the second compartment 14 at the downstream end of the cartridge body portion 8, and a second position relative to the cartridge 4, in which the second seal 26 at the upstream end of the mouthpiece body portion 22 is spaced apart from the first air outlet of the first compartment 12 and the second air outlet of the second compartment 14 at the downstream end of the cartridge body portion 8.

FIG. 7 shows an aerosol-generating system according to an embodiment of the invention for generating an aerosol comprising nicotine salt particles.

The aerosol-generating system comprises the cartridge assembly 200 according to the second embodiment of the invention shown in FIG. 6 and an aerosol-generating device 34.

The aerosol-generating device 34 comprises a device housing 36 defining a device cavity 38 for receiving an upstream end portion of the cartridge 4 of the cartridge assembly 200.

The aerosol-generating device 34 comprises a heating element (not shown) configured to heat the first compartment 12 and the second compartment 14 of the cartridge 4 of the cartridge assembly 200. The heating element is an elongate electric heating element. The heating element is located within the device cavity 38 of the aerosol-generating device 34 and extends along the longitudinal axis of the device cavity 38.

The aerosol-generating device 34 further comprises a power supply and a controller (not shown) for controlling a supply of power from the power supply to the heating element. The power supply and the controller are housed in the device housing 36 of the aerosol-generating device 34.

To use the aerosol-generating system, the removable first seal 20 secured to the upstream end of the cartridge 4 of the cartridge assembly 200 is removed. With the mouthpiece 6 in the first position relative to the cartridge 4, the upstream end of the cartridge 4 of the cartridge assembly 200 is then inserted into the device cavity 38 of the aerosol-generating device 34 as shown by the straight arrow in the upper drawing in FIG. 7. As the upstream end of the cartridge 4 of the cartridge assembly 200 is inserted into the device cavity 38, the heating element located within the device cavity 38 of the aerosol-generating device 34 is received in the heater compartment 16 located between the first compartment 12 and the second compartment 14 of the cartridge body portion 8 of the cartridge 4.

As shown in the central drawing in FIG. 7, when the upstream end of the cartridge 4 of the cartridge assembly 200 has been inserted into the device cavity 38 of the aerosol-generating device 34 and the mouthpiece 6 is in the first position relative to the cartridge 4, the upstream end of the mouthpiece housing portion 24 of the mouthpiece 6 abuts a downstream end of the device housing 36 of the aerosol-generating device 34. This may indicate to a user that the mouthpiece body portion 22 is in the first position relative to the cartridge 4.

To create airflow pathways through the cartridge assembly 200, the mouthpiece 6 of the cartridge assembly 200 is turned through 90 degrees with respect to the cartridge 4 of the cartridge assembly 200 from the first position relative to the cartridge 4 to the second position relative to the cartridge 4 as shown by the curved arrow in the lower drawing in FIG. 7.

As shown in the lower drawing in FIG. 7, when the mouthpiece 6 is in the second position relative to the cartridge 4, the upstream end of the mouthpiece housing portion 24 of the mouthpiece 6 is spaced apart from the downstream end of the device housing 36 of the aerosol-generating device 34. This may indicate to a user that the mouthpiece body portion 22 is in the second position relative to the cartridge 4.

As described above, when the mouthpiece 6 is in the second position relative to the cartridge 4 a user draws on the downstream end of the mouthpiece 6 to draw a first air stream through the first compartment 12 of the cartridge 4 and a second air stream through the second compartment 14 of the cartridge 4. As the first air stream is drawn through the first compartment 12 of the cartridge 4, nicotine vapour is released from the first carrier material into the first air stream. As the second air stream is drawn through the second compartment 14 of the cartridge 6, acid vapour is released from the second carrier material into the second air stream.

The nicotine vapour in the first air stream and the acid vapour in the second air stream react with one another in the gas phase in the mouthpiece body portion 22 to form an aerosol of nicotine salt particles, which is delivered to the user through the proximal end of the mouthpiece 6 through the air outlet of the mouthpiece body portion 22.

During use of the aerosol-generating system, the controller of the aerosol-generating device 34 controls the supply of power from the power supply of the aerosol-generating device 34 to the heating element of the aerosol-generating device to heat the first compartment 12 and the second compartment 14 of the cartridge 4 to a temperature of about 100° C. to about 115° C.

The mouthpiece 6 may be turned through 90 degrees with respect to the cartridge 4 back from the second position relative to the cartridge 4 shown in the lower drawing in FIG. 7 to the first position relative to the cartridge 4 shown in the central drawing in FIG. 7. As described previously above, this may substantially prevent the loss of nicotine vapour from the first compartment 12 and acid vapour from the second compartment 14 of the cartridge 4 when the aerosol-generating system is not being used.

The mouthpiece 6 may be turned through 90 degrees with respect to the cartridge 4 back from the second position relative to the cartridge 4 without removing the cartridge of the cartridge assembly 200 from the device housing of the aerosol-generating device 34.

The mouthpiece 6 may be moveable repeatedly between the first position relative to the cartridge 4 shown in the central drawing in FIG. 7 and the second position relative to the cartridge 4 shown in the lower drawing in FIG. 7 without removing the cartridge assembly 200 from the aerosol-generating device 34 to facilitate multiple uses of the aerosol-generating system by a user.

The aerosol-generating system shown in FIG. 7 comprises the cartridge assembly 200 according to the second embodiment of the invention shown in FIG. 6. In an alternative embodiment (not shown), the aerosol-generating system may comprise the cartridge assembly 2 according to the first embodiment of the invention shown in FIGS. 1-5.

In the aerosol-generating system shown in FIG. 7, the aerosol-generating device 34 comprises an electric heating element within the device cavity and the cartridge body portion 8 of the cartridge 4 of the cartridge assembly 200 comprises a heater compartment 16 for receiving the heating element.

In an alternative embodiment (not shown), the aerosol-generating device may comprise an inductive heating element in the form of an inductor coil circumscribing the device cavity and the cartridge assembly 200 may comprise a susceptor located within the heater compartment 16 of the cartridge body portion 8 of the cartridge 4. In this alternative embodiment, during use the controller of the aerosol-generating device 34 controls the supply of an alternating electric current from the power supply of the aerosol-generating device 34 to the inductor coil, such that the inductor coil generates an alternating magnetic field to heat the susceptor within the heater compartment 16 of the cartridge body portion 8 of the cartridge 4. Once heated, the susceptor heats the first compartment 12 and the second compartment 14 of the cartridge 4 of the cartridge assembly 200.

In an alternative embodiment (not shown), rather than comprising a heater compartment 16 for receiving a heating element configured to heat the first compartment 12 and the second compartment 14 of the cartridge 4 or a heater compartment 16 comprising a susceptor configured to heat the first compartment 12 and the second compartment 14 of the cartridge 4, the cartridge body portion 8 of the cartridge 4 may comprise a heating element located between the first compartment 12 and the second compartment 14. In such embodiments, the aerosol-generating device 34 may be configured to supply power to the heating element of the cartridge body portion 8 of the cartridge 4 by means of one or more connection points of the heating element at the upstream end of the cartridge 4.

FIG. 8 shows the cartridge actuation portion and the mouthpiece actuation portion of a cartridge assembly according to a third embodiment of the invention. The cartridge assembly according to the third embodiment of the invention is of similar construction as the cartridge assembly 2 according to the first embodiment of the invention shown in FIGS. 1-5. Like the cartridge assembly shown in FIGS. 1-5, the cartridge assembly according to the third embodiment of the invention comprises a cartridge 4 comprising a cartridge body portion 8, a cartridge housing portion 10 and a removable first seal 20. Like the cartridge assembly 2 shown in FIGS. 1-5, the cartridge assembly according to the third embodiment of the invention also comprises a mouthpiece 6 comprising a mouthpiece body portion 22, a mouthpiece housing portion 24 and a second seal 26.

As shown in FIG. 8, in the cartridge assembly according to the third embodiment of the invention the cartridge actuation portion 18 comprises a longitudinal guide slot provided on an inner surface of a downstream end portion of the cartridge housing portion 10 of the cartridge of the cartridge assembly and the mouthpiece actuation portion 28 comprises an outwardly projecting pin provided on an outer surface of an upstream end portion of the mouthpiece element 22 of the mouthpiece of the cartridge assembly. As shown in FIG. 8, the outwardly projecting pin of the mouthpiece actuation portion 28 is engaged with longitudinal guide slot of the cartridge actuation portion 18.

The longitudinal guide slot of the cartridge actuation portion 18 and the outwardly projecting pin of the mouthpiece actuation portion 28 of the cartridge assembly according to the third embodiment of the invention are configured for two-way translational movement of the mouthpiece body portion 22 with respect to the cartridge 4. The mouthpiece 6 may be moved linearly with respect to the cartridge 4 in opposite directions to effect translational movement of the mouthpiece body portion 22 between a first position relative to the cartridge 4, in which the second seal 26 at the upstream end of the mouthpiece body portion 22 abuts and obstructs the first air outlet of the first compartment 12 and the second air outlet of the second compartment 14 at the downstream end of the cartridge body portion 8, and a second position relative to the cartridge 4, in which the second seal 26 at the upstream end of the mouthpiece body portion 22 is spaced apart from the first air outlet of the first compartment 12 and the second air outlet of the second compartment 14 at the downstream end of the cartridge body portion 8.

The distance that the mouthpiece 6 may be moved linearly with respect to the cartridge 4 is defined by the length of the longitudinal guide slot of the cartridge actuation portion 18 and the diameter of the outwardly projecting pin of the mouthpiece actuation portion 28. When the outwardly projecting pin of the mouthpiece actuation portion 28 abuts an upstream end G of the longitudinal guide slot of the cartridge actuation portion 18, the mouthpiece body portion 22 is in the first position relative to the cartridge 4. When the outwardly projecting pin of the mouthpiece actuation portion 28 abuts a downstream end H of the longitudinal guide slot of the cartridge actuation portion 18, the mouthpiece body portion 22 is in the second position relative to the cartridge 4.

As shown in FIG. 8, constricted portions are disposed adjacent the upstream end G and the downstream end H of the longitudinal guide slot of the cartridge actuation portion 18. In use additional force must be applied by a user to linearly move the outwardly projecting pin of the mouthpiece actuation portion 28 beyond the constricted portions to the upstream end G and the downstream end H of the longitudinal guide slot of the cartridge actuation portion 18. The mouthpiece body portion 22 is thereby retained in the first position and the second position relative to the cartridge 4 until sufficient force is applied by the user to effect translational movement of the mouthpiece body portion 22 between the first position and the second position.

Linear movement of the outwardly projecting pin of the mouthpiece actuation portion 28 beyond the constricted portions to the upstream end G and the downstream end H of the longitudinal guide slot of the cartridge actuation portion 18 may also produce an audible click to indicate to a user that the mouthpiece body portion has reached the second position and the first position.

In an alternative embodiment (not shown), the cartridge actuation portion 18 may comprise a plurality of longitudinal guide slots provided on an inner surface of a downstream end portion of the cartridge housing portion 10 of the cartridge of the cartridge assembly and the mouthpiece actuation portion 28 may comprise a plurality of outwardly projecting pins provided on an outer surface of the mouthpiece body portion of the mouthpiece of the cartridge assembly, wherein each of the plurality of outwardly projecting pins is engaged with one of the plurality of longitudinal guide slots.

The plurality of guide slots may be spaced-apart around the inner surface of the downstream end portion of the cartridge housing portion 10 of the cartridge 4 of the cartridge assembly and the plurality of projections may be spaced-apart around the outer surface of the mouthpiece body portion 22 of the mouthpiece 6 of the cartridge assembly.

For example, the cartridge actuation portion 18 may comprise three longitudinal guide slots spaced-apart at 120 degree intervals around the inner surface of the downstream end portion of the cartridge 4 of the cartridge assembly and the mouthpiece actuation portion 28 may comprise three outwardly projecting pins spaced-apart at 120 degree intervals around the outer surface of the mouthpiece body portion 22 of the mouthpiece 6 of the cartridge assembly.

1. A cartridge assembly for use in an aerosol-generating system, the cartridge assembly comprising:
a cartridge having an upstream end and a downstream end, the cartridge comprising:
at least one compartment having an air inlet at the upstream end of the cartridge and an air outlet downstream of the air inlet;
a removable first seal secured to the upstream end of the cartridge, wherein the removable first seal obstructs the air inlet of the at least one compartment and is configured to be removed by a user prior to use of the cartridge assembly; and
a cartridge actuation portion on an inner surface of a downstream end portion of the cartridge;
a mouthpiece comprising:
a mouthpiece body portion having an upstream end and a downstream end, the mouthpiece body portion having an air inlet at the upstream end of the mouthpiece body portion and an air outlet at the downstream end of the mouthpiece body portion;
a second seal at the upstream end of the mouthpiece body portion; and
a mouthpiece actuation portion on an outer surface of the mouthpiece body portion,
wherein the mouthpiece actuation portion is engaged with the cartridge actuation portion and wherein the mouthpiece actuation portion and the cartridge actuation portion are configured so that the mouthpiece body portion is moveable with respect to the cartridge from a first position, in which first position the second seal abuts and obstructs the air outlet of the at least one compartment, to a second position, in which second position the second seal is spaced apart from the air outlet of the at least one compartment and the air outlet of the at least one compartment is in fluid communication with the air inlet of the mouthpiece body portion.

2. A cartridge assembly according to claim 1, wherein the mouthpiece actuation portion and the cartridge actuation portion are configured for two-way movement of the mouthpiece body portion with respect to the cartridge so that the mouthpiece body portion is moveable with respect to the cartridge from the second position to the first position.

3. A cartridge assembly according to claim 1, wherein the cartridge comprises a first mechanical stop and the mouthpiece body portion comprises a second mechanical stop and wherein the first mechanical stop engages the second mechanical stop when the mouthpiece body portion is in the second position.

4. A cartridge assembly according to claim 1, wherein cartridge actuation portion comprises a guide slot and the mouthpiece actuation portion comprises a projection engaged with the guide slot.

5. A cartridge assembly according to claim 1, wherein the mouthpiece actuation portion and the cartridge actuation portion are configured so that the mouthpiece body portion is translationally and rotationally moveable with respect to the cartridge.

6. A cartridge assembly according to claim 5, wherein the mouthpiece actuation portion and the cartridge actuation portion are configured so that the mouthpiece body portion is helicoidally moveable with respect to the cartridge.

7. A cartridge assembly according to claim 6, wherein the cartridge actuation portion comprises a first helical thread and the mouthpiece actuation portion comprises a second helical thread engaged with the first helical thread.

8. A cartridge assembly according to claim 5, wherein the cartridge assembly is configured to define the second position of the mouthpiece body portion at an angular rotation with respect to the cartridge of between about 80 degrees and about 100 degrees from the first position or at an angular rotation with respect to the cartridge of between about 170 degrees and about 190 degrees from the first position.

9. A cartridge assembly according to claim 1, wherein the cartridge comprises:
a cartridge body portion defining the at least one compartment; and
a cartridge housing portion defining a cartridge cavity,
wherein at least a downstream end portion of the cartridge body portion is secured within an upstream end portion of the cartridge cavity and wherein the cartridge actuation portion is on an inner surface of a downstream end portion of the cartridge cavity.

10. A cartridge assembly according to claim 9 wherein the air outlet of the at least one compartment is at a downstream end of the cartridge body portion and wherein in the first position the second seal abuts the downstream end of the cartridge body portion and in the second position the second seal is spaced apart from the downstream end of the cartridge body portion.

11. A cartridge assembly according to claim 1, wherein the mouthpiece comprises:
a mouthpiece housing portion defining a mouthpiece cavity,
wherein the mouthpiece body portion is secured within a downstream end portion of the mouthpiece cavity and wherein at least a downstream end portion of the cartridge is received in an upstream end portion of the mouthpiece cavity.

12. A cartridge assembly according to claim 1, wherein the at least one compartment comprises a first compartment having a first air inlet at the upstream end of the cartridge and a first air outlet downstream of the first air inlet and a second compartment having a second air inlet at the upstream end of the cartridge and a second air outlet downstream of the second air inlet.

13. A cartridge assembly according to claim 12, wherein the cartridge comprises a nicotine source within the first compartment and an acid source within the second compartment.

14. A cartridge assembly according to claim 1, wherein the cartridge comprises a heater compartment for receiving a heating element of an aerosol-generating device.

15. A cartridge assembly according to claim 1, wherein the cartridge comprises a susceptor.

16. An aerosol-generating system comprising:
a cartridge assembly according to claim 1; and
an aerosol-generating device comprising:
a device housing defining a device cavity configured to receive at least an upstream end portion of the cartridge of the cartridge assembly; and
a heating element for heating the at least one compartment of the cartridge of the cartridge assembly.

17. An aerosol-generating system according to claim 16, wherein the heating element is located within the device cavity, and wherein the cartridge comprises a heater compartment for receiving the heating element.

18. An aerosol-generating system according to claim 16 wherein the heating element comprises an inductor coil surrounding at least a portion of the device cavity, and wherein the cartridge comprises a susceptor.
